(19) United States
(12) Patent Application Publication
(10) Pub. No.: US 2024/0096092 A1
(43) Pub. Date: Mar. 21, 2024

(54) Systems and Methods for Automated Hyperspectral Vegetation Index Derivation for High-Throughput Plant Phenotyping

(71) Applicant: Agriculture Victoria Services Pty Ltd., Bundoora (AU)

(72) Inventors: Joshua Chee Oon Koh, Bundoora (AU); Bikram Pratap Banerjee, Bundoora (AU); German Carlos Spangenberg, Bundoora (AU); Surya Kant, Bundoora (AU)

(21) Appl. No.: 18/272,728

(22) PCT Filed: Jan. 27, 2022
(86) PCT No.: PCT/AU2022/050037

§ 371 Date: Jul. 17, 2023

(30) Foreign Application Priority Data
Jan. 29, 2021 (AU) 2021900198

(51) Int. Cl. G06V 20/10

(52) U.S. Cl. CPC G06V 20/188; G06V 20/194

(57) ABSTRACT

The present invention is directed to a method for automated hyperspectral vegetation index (VI) determination, including: accessing measured spectra and respective measured ground truth values of a selected vegetation trait; accessing a library of VI models, each model including a relationship defining an index value for the vegetation trait by mathematically combining spectral measurement values at a plurality of wavebands; selecting a VI model from the library; generating a hyperparameter for each of the spectral measurement values of the selected model, the hyperparameter including a selected waveband for each of the plurality of model wavebands; evaluating the selected model with the selected wavebands with an objective function score; a model parameter tuning step using an optimizer to select the waveband for each of the at least two wavebands based on sequential model-based optimization (SMBO); and repeating the model selection, generation, evaluation and tuning steps for a plurality of iterations.

### TECHNICAL FIELD

The present disclosure relates to systems and methods for automated hyperspectral vegetation index derivation for high-throughput plant phenotyping, including using a hyperparameter optimization framework.

### BACKGROUND

High-throughput phenotyping (HTP) of plants may be integral in meeting the demand for large-scale evaluation of genotypes in breeding programs and crop management systems (Tardieu et al., 2017; Mir et al., 2019). In recent years, controlled environment and field-based HTP platforms have been developed to monitor plants at the canopy or plot level for a large number of crop lines (Tardieu et al., 2017; Mir et al., 2019; Lu et al., 2020). Central to the success of these HTP platforms is the use of various imaging sensors to acquire morphological, physiological and biochemical parameters in a non-invasive manner. Hyperspectral imaging may be a promising HTP technology in measuring biochemical and morpho-physiological traits in a fast and non-destructive manner by detecting signatures in the reflectance spectrum of vegetation in narrow and contiguous spectral wavebands (Lu et al., 2020) because the spectral reflectance of vegetation is determined by chemical and morphological characteristics of leaves or surface organs (Zhang & Kovacs, 2012) and the characteristic spectra vary with plant type, water content within tissues, and other intrinsic factors (Thenkabail et al., 2000; Liu et al., 2016). Therefore, dynamic changes in the physiological and biochemical constituents of plants may be detected using hyperspectral narrow wavebands (Thenkabail et al., 2000; Thenkabail et al., 2011; Zhu et al., 2012). Recent availability of lightweight hyperspectral sensors may allow use of these sensors in unmanned aerial vehicle (UAV) systems for HTP and precision agriculture (Adão et al., 2017; Lu et al., 2020). Example applications include estimation of crop parameters such as biomass, nitrogen, chlorophyll and water content, in addition to weeds classification and diseases detection (Xue & Su, 2017). Apart from this, close-range hyperspectral imaging (ground-based or glasshouse) characterized by high spatial resolution and signal-to-noise ratio may be found in HTP facilities: these systems allow fine-scale investigation of vegetative features at the leaf or canopy level with applications in plant water content and biochemical compounds estimation, and detection of abiotic and biotic stresses in plants (Mishra et al., 2017).

However, the large amount of data collected by hyperspectral sensors poses challenges in analytical implementations. Redundancy problems linked to the multicollinearity of wavebands and the curse of high dimensionality impose high computational costs on analytical pipelines (Bajwa & Kulkarni, 2011; Burger & Gowen, 2011). Dedicated efforts are often required to develop efficient hyperspectral data processing workflows for a specific plant phenotyping task (Aasen et al., 2014; Aasen et al., 2018). Hyperspectral vegetation indices (VIs) may offer a quick and easy way to derive potentially informative values associated with the underlying plant trait of interest (Silleos et al., 2006; Xue & Su, 2017). Traditionally, VIs were constructed by formulating algebraic combinations of the vegetative reflectance at different wavebands, selected from the visible (VIS, 400-700 nm), near infrared (NIR, 700-1000 nm) and the shortwave infrared (SWIR, 1000-2500 nm) regions. Pearson and Miller (1972) were pioneers in the history of VIs with the development of the ratio vegetation index (RVI) and vegetation index number (VIN), for the estimation of vegetative covers, which was followed by the development of the normalized difference vegetation index (NDVI) for measuring biophysical attributes of plants (Rouse et al., 1974). More than 500 hyperspectral VIs have been developed over the past 47 years (˜10.6 VIs per year), demonstrating a strong and continued interest in the development and adoption of novel VIs for specific remote sensing applications (Henrich et al., 2017). However, existing VIs may consist predominantly of 2-band indices and to some extent, 3-band indices, which limits the amount of information represented and thereby the net performance afforded by these VIs (Henrich et al., 2017), and existing VIs may be designed for specific plant traits and often do not generalize well for other traits. For example, the usefulness of a VI for measuring a different trait than it was originally designed for needs to be determined empirically through trial and error, and for different plant species and growth stages, making it a potentially time-consuming and often a hit-or-miss affair (Koppe et al., 2010; Li et al., 2010; Din et al., 2017). Thus, particularly in agriculture, there is a strong/continued demand for novel VIs that can target specific traits associated with crop growth, biochemical parameters, yield and quality.

The development of VIs is technically challenging and time consuming, often requiring a comprehensive understanding of the dynamic changes of the plant optical properties in relation to the intrinsic biochemical or biophysical trait(s) of interest. To this end, a wide variety of experiments have been proposed to acquire a comprehensive spectral library (Rao et al., 2007; Chauhan & Mohan, 2013). Ideally, knowledge on wavebands associated with plant traits may be enriched or expanded with successive development of new VIs when different regions of the reflectance spectrum corresponding to vegetative features are identified. Biochemical and biophysical traits can be described more comprehensively with more wavebands, with each waveband adding supplementary information. However, this is seldom the case as the VIs rarely constitute a complex or cohesive assemblage of wavebands but rather a limited selection of a few wavebands (fewer than 4 wavebands). In addition, multicollinearity of wavebands and the curse of high dimensionality inherent in hyperspectral data complicates the identification of wavebands linked to the underlying trait of interest. Several attempts have been made to accelerate the development of novel VIs, these include the use of correlation matrices between VIs and the target traits of interest to retrieve new waveband or index combinations (Thenkabail et al., 2004; Aasen et al., 2014; Xu et al., 2019), careful selection of hyperspectral features (i.e., wavebands) (Aasen et al., 2014; Aasen et al., 2018), and a brute force indices mining approach to identify a new normalized difference chlorophyll index (NDCI_w) for the estimation of chlorophyll content in wheat (Banerjee et al., 2020). However, these approaches are mainly suited for the evaluation of a limited number of wavebands and/or index model combinations for the development of new VIs, and may be computationally less efficient when dealing with a greater number of wavebands and index models. Efficient methods and systems for evaluation of VIs and waveband selection may be crucial to the development of trait-specific hyperspectral VIs for HTP and agriculture remote sensing.

In high-throughput plant phenotyping, the parametric response of characteristic plant traits to VIs are seldom linear and tend to vary with growth stages, influencing the retrieval of potential VIs (Li et al., 2010; Gnyp et al., 2014; Wen et al., 2019). For example, studies in the application of VIs for rice biomass estimation showed that different regions in the leaf and canopy reflectance spectrum correlated with biomass at different growth stages and it was not possible to derive a VI that is applicable across individual and combined time points (Stroppiana et al., 2009; Aasen et al., 2014; Gnyp et al., 2014). Similarly, the newly developed NDCI, for wheat chlorophyll estimation only showed strong correlation (R²=0.71-0.92) with chlorophyll levels at later vegetative growth stages but performed poorly (R²=0.59) at early growth stages (Banerjee et al., 2020).

It is desired to address or ameliorate one or more disadvantages or limitations associated with the prior art, or to at least provide a useful alternative.

### SUMMARY

Disclosed herein is a method and a system for automated hyperspectral vegetation index (VI) determination, i.e., selection and optimization of a VI model, including its wavebands and its coefficients, for a selected vegetation trait (or “plant trait”).

The method includes:
a. accessing measured spectra and respective measured ground truth values of a selected vegetation trait;
b. accessing a library of VI models, wherein each VI model includes a relationship defining an index value for the vegetation trait by mathematically combining spectral measurement values at a plurality of wavebands (“model wavebands”), optionally with one or more coefficients (“model coefficients”);
c. a model selection step, including selecting a VI model from the library of VI models;
d. a model parameter generation step, including:
   i. generating a hyperparameter for each of the spectral measurement values of the selected VI model, wherein the hyperparameter includes a selected waveband for each of the plurality of model wavebands, and
   ii. additionally, generating a hyperparameter for each of the model coefficients of the selected VI model (if the selected VI model has any coefficients), wherein the hyperparameter includes selected coefficient value for each of the model coefficients;
e. a model evaluation step, including evaluating the selected VI model with the selected wavebands and optionally selected coefficient values with an objective function score, wherein the objective function score quantifies a closeness of fit between the ground truth values and calculated VI values from the selected VI model with the generated hyperparameters and the respective measured spectra;
f. a model parameter tuning step, including using an optimizer to select the waveband for each of the at least two wavebands (“optimum wavebands”), and optionally to select the coefficient values for each of the coefficients (“optimum coefficient values”) based on sequential model-based optimization (SMBO); and
g. repeating the model selection step, the model parameter generation step, the model evaluation step and the model parameter tuning step (together referred to as the “optimization steps”) for a plurality of iterations.

The SMBO may be Bayesian SMBO, and the optimizer may be a Bayesian optimizer. The Bayesian optimizer may be a Tree-Structured Parzen Estimator (TPE).

The method includes selecting the VI model with the selected optimum wavebands and optimum coefficient values, i.e., the VI model with hyperparameters that generates the highest object function score over all iterations.

The method may include creating the library of VI models.

The method may additionally include:
a. a grouping step, including grouping VI models from the library according the number (N_{wb}) of the model wavebands, including a first group with a plurality of two-waveband models (N_{wb}=2) and a second group with a plurality of three-waveband models (N_{wb}=3);
b. a running step, including determining the best-performing VI model within each group by a plurality of the iterations of the optimization steps for each group; and
c. a cross-group comparison step, including selecting an overall best VI model from the best-performing VI models (based on their respective objective function scores).

The method may include analysis of samples of the plant to generate the spectrum (“spectral measurements”) of the plant, which can be the reflectance spectrum, and the ground truth value. The method may include using a hyperspectral imaging sensor or spectrometer to generate the spectral measurements. The method may include imaging plants in three different angles (0°, 120°, and 240°), with the plants being rotated to the angles using a lifter and turner assembly.

The at least two wavebands include a plurality of different wavebands selected from the visible (VIS, 400-700 nm), near infrared (NIR, 700-1000 nm) and shortwave infrared (SWIR, 1000-2500 nm) regions. The wavebands may be selected from the shortwave infrared (SWIR) region spanning 1200-1700 nm, in particular around 1410-1430 nm and 1550-1680 nm. The wavebands may be selected from the near infrared (NIR) region spanning 800-900 nm. The wavebands may include a plurality of measured wavebands in the range 400 nm to 5,400 nm, e.g., over 1,000 wavebands, over 2,000 wavebands, over 3,000 wavebands, over 4,000 wavebands, or over 5,000 wavebands, based on the number of wavebands in the spectrum from the hyperspectral imaging sensor or spectrometer.

Disclosed herein is a system configured to perform the method.

The system includes an optimizer module (or “optimizer”) configured to perform the optimization steps, including the model selection step, the model parameter generation step, the model parameter tuning step and the model evaluation step.

The system may include: one or more hyperspectral sensors, optionally mounted to an unmanned aerial vehicle (UAV) system.

The system may include: a hyperspectral imaging station (including a sensor or spectrometer) to generate the spectrum; and a lifter and turner assembly for imaging plants in three different angles (0°, 120°, and 240°) to generate the spectrum of the plant. The hyperspectral imaging station may include a pushbroom-type imaging spectrometer operational over a spectral range of 475-1710 nm and a spectral resolution of less than 10 nm.

Disclosed herein is machine-readable storage media including machine readable instructions that, when executed by a computing system, perform data-processing steps of the method, including one or more of the accessing steps, the model selection step, the model parameter generation step, the model parameter tuning step, the model selection step, the grouping step, the running step, and the cross-group comparison step. The machine readable instructions that, when executed by a computing system, provide the functionality of the optimizer.

### BRIEF DESCRIPTION OF THE DRAWINGS

Some embodiments of the present invention are hereinafter described, by way of example only, with reference to the accompanying drawings, in which:

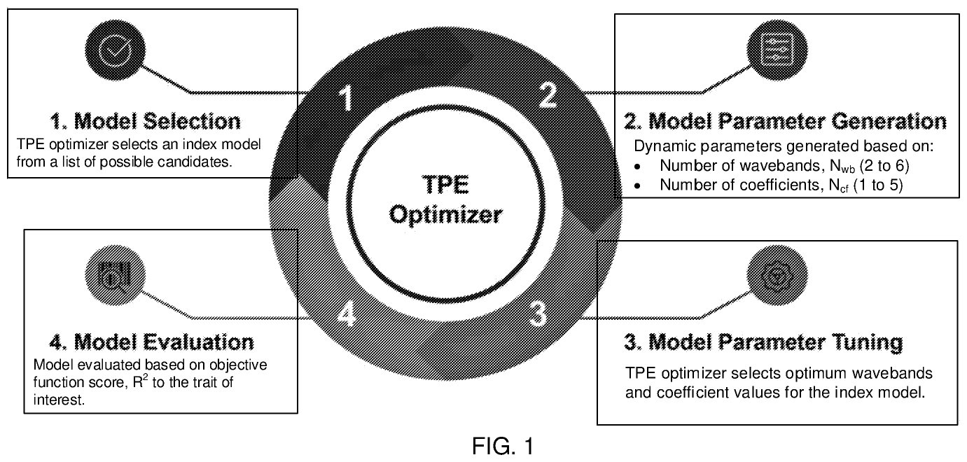

a. FIG. 1 is a flow diagram the AutoVI method;

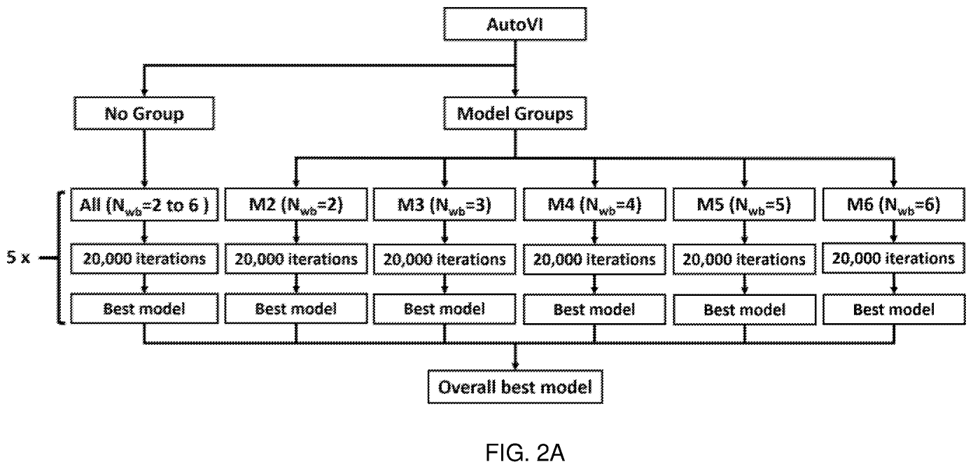

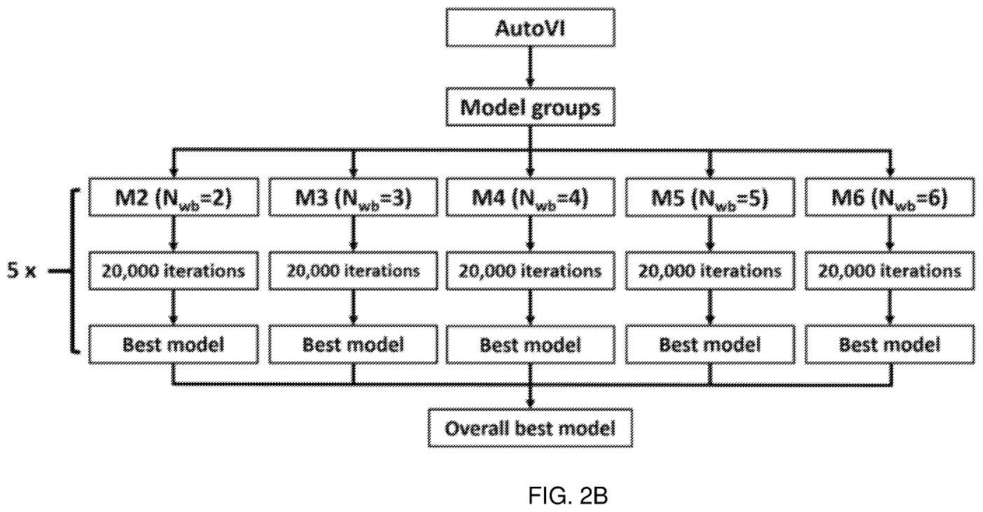

b. FIG. 2A is a flowchart for grouped model evaluations in the AutoVI method including ‘no group’ evaluations;

c. FIG. 2B is a flowchart for grouped model evaluations in the AutoVI method, without ‘no group’ evaluations, grouped according to the number of wavebands;

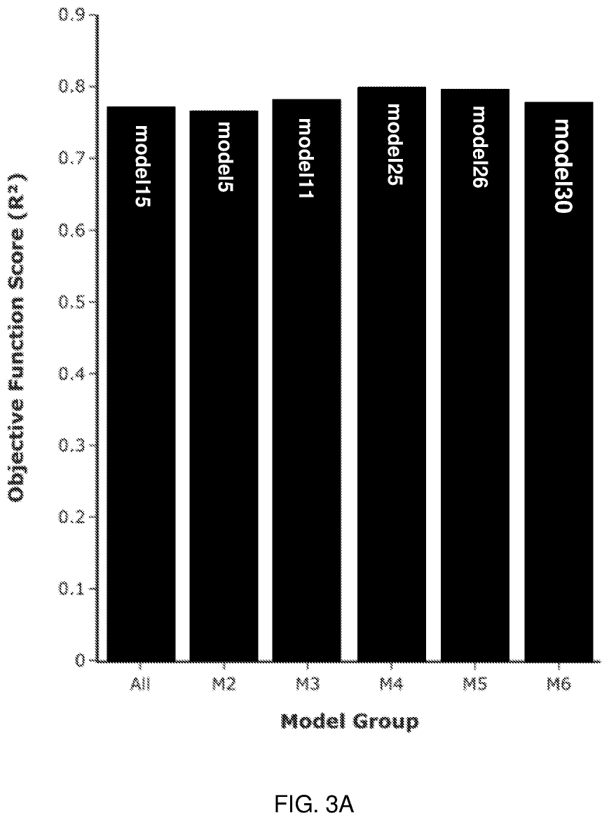

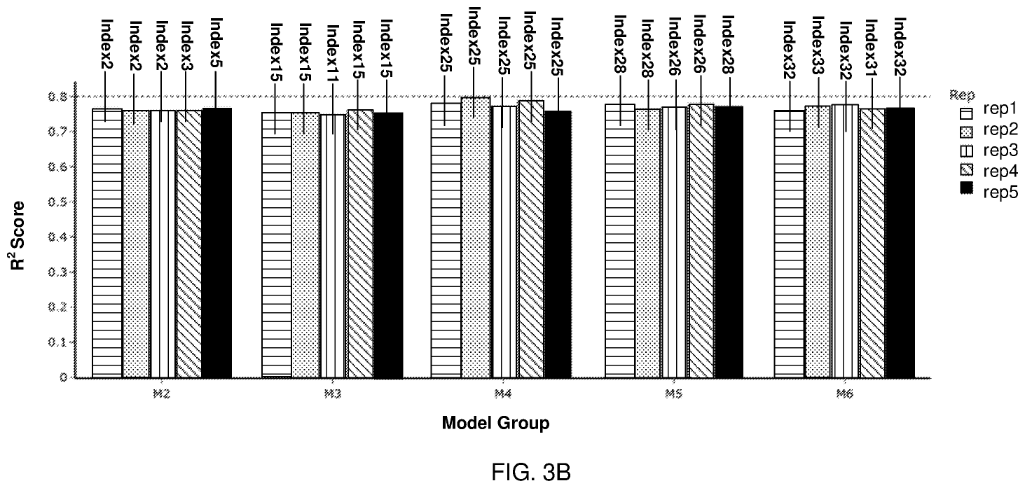

d. FIG. 3A is a graph of objective function scores of best-performing index models from grouped model evaluations for a first total chlorophyll content estimation;

e. FIG. 3B is a graph of objective function scores of best-performing index models from grouped model evaluations for a second total chlorophyll content estimation;

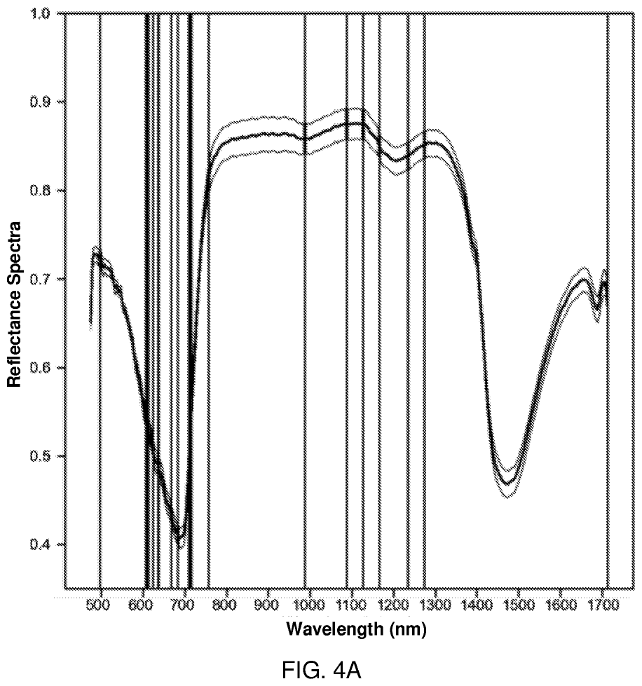

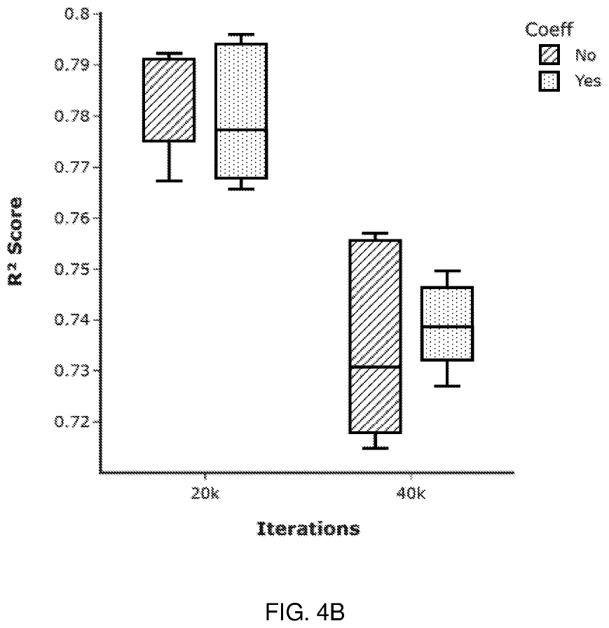

f. FIG. 4A is a spectrum showing selected wavebands for the first total chlorophyll content estimation;

g. FIG. 4B is graph of objective function scores showing effects of coefficient tuning and longer iterations in the second total chlorophyll content estimation, including inclusion (“Yes”) and exclusion (“No”) of a single coefficient, a, on AutoVI-Chl performance across repeated computations at 20,000 (20 k) and 40,000 (40 k) iterations each with the distribution of R² scores in boxplots;

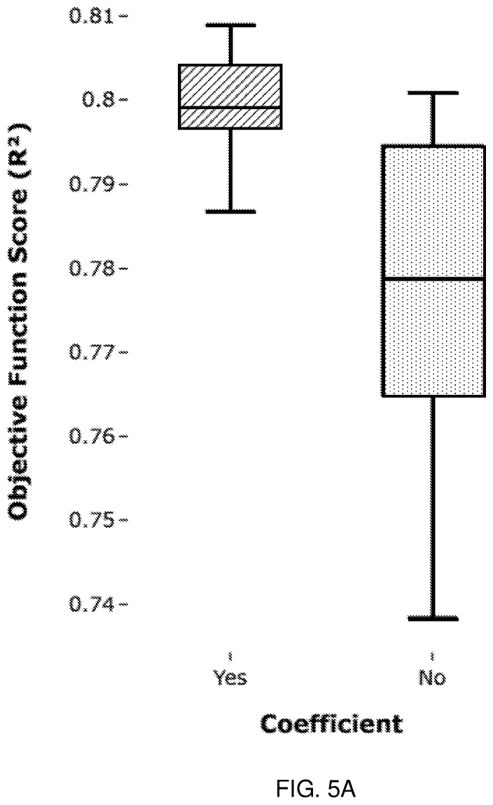

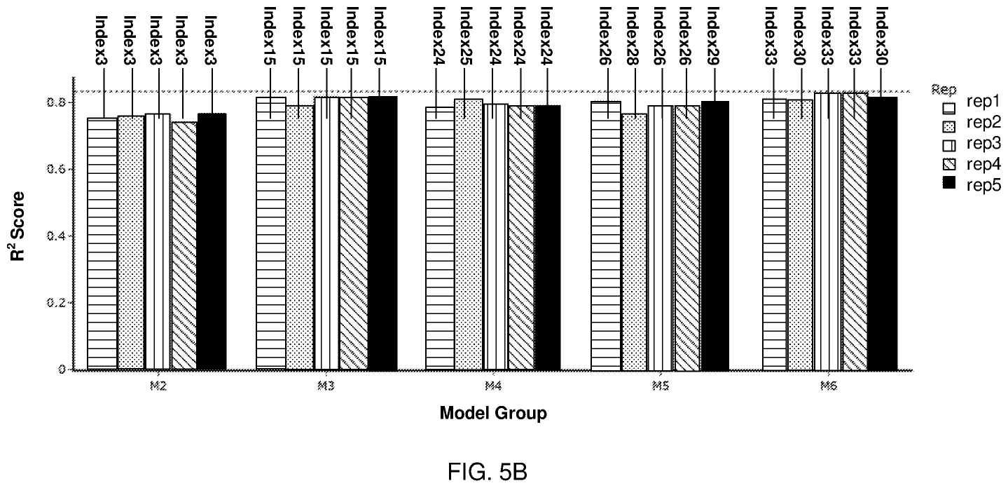

h. FIG. 5A is a graph of objective function scores showing an effect of coefficient tuning on AutoVI-CI performance;

i. FIG. 5B is a graph of objective function scores of best-performing index models for a second total sugar content estimation;

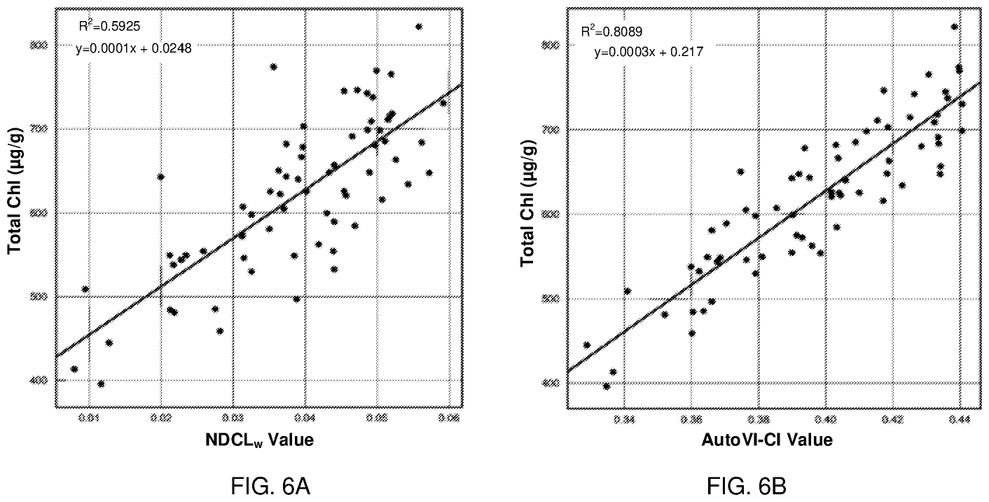

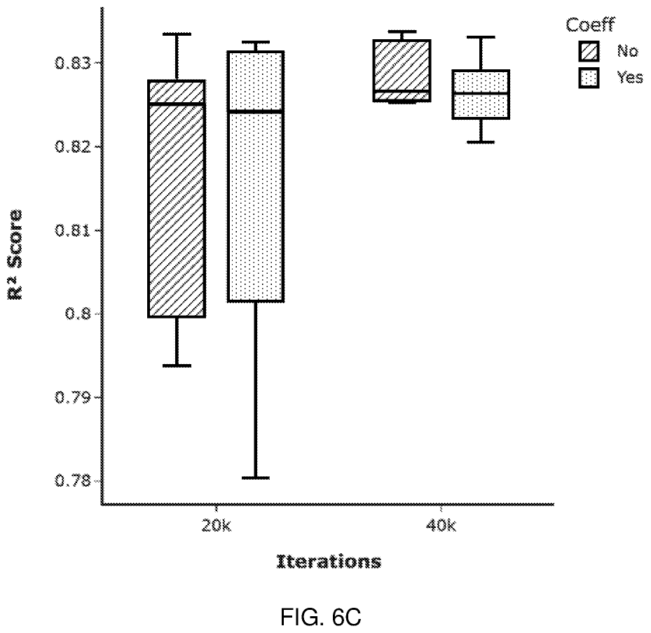

j. FIGS. 6A and 6B are graphs of total chlorophyll content estimation across entire wheat growth period with (a) NDCIw and (b) AutoVI-CI;

k. FIG. 6C is a graph of objective function scores showing effects of coefficient tuning and longer iterations in the second total sugar content estimation, including inclusion (“Yes”) and exclusion (“No”) of a single coefficient, a, on AutoVI-Sgr performance across repeated computations at 20,000 (20 k) and 40,000 (40 k) iterations each with the distribution of R² scores in boxplots;

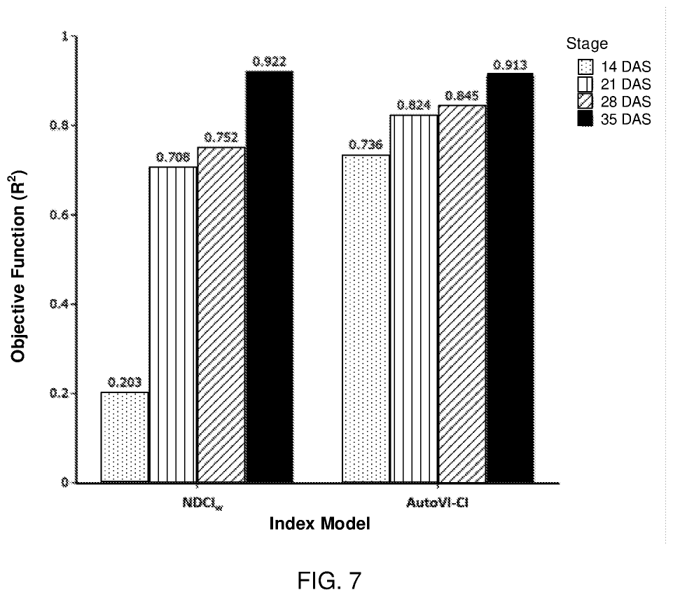

l. FIG. 7 is graph of total chlorophyll content estimation across individual wheat growth periods with NDCIw and AutoVI-CI;

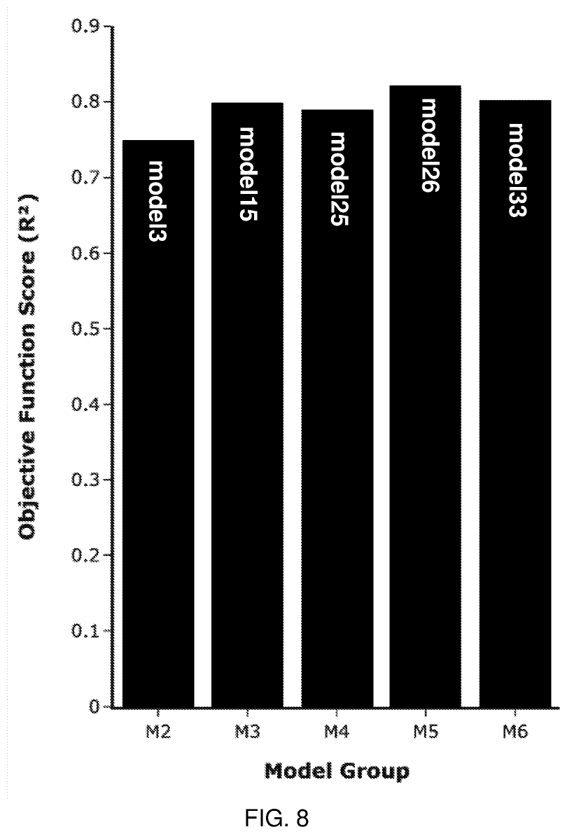

m. FIG. 8 is a graph of objective function scores of best-performing index models from grouped model evaluations for a first total sugar content estimation;

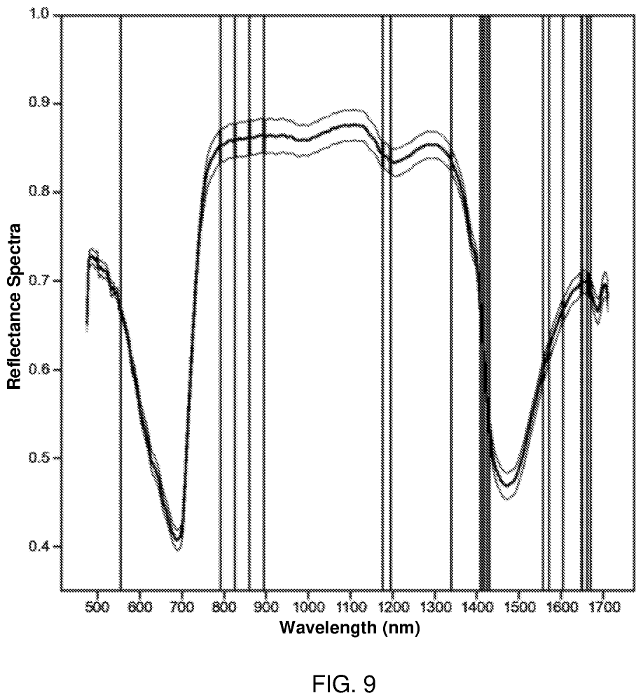

n. FIG. 9 is a spectrum showing selected wavebands for total sugar content estimation;

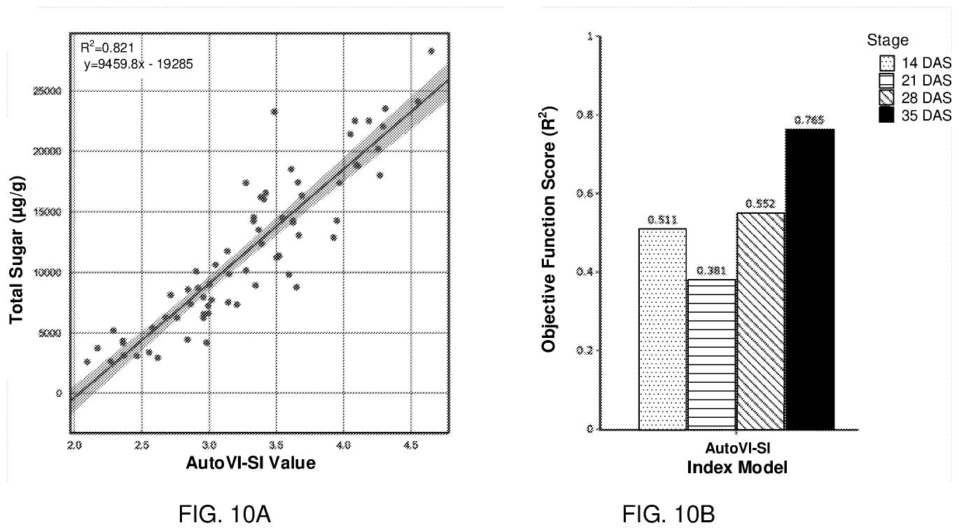

o. FIGS. 10A and 10B are graphs of total sugar content estimation across individual and entire wheat growth period with AutoVI-SI; and

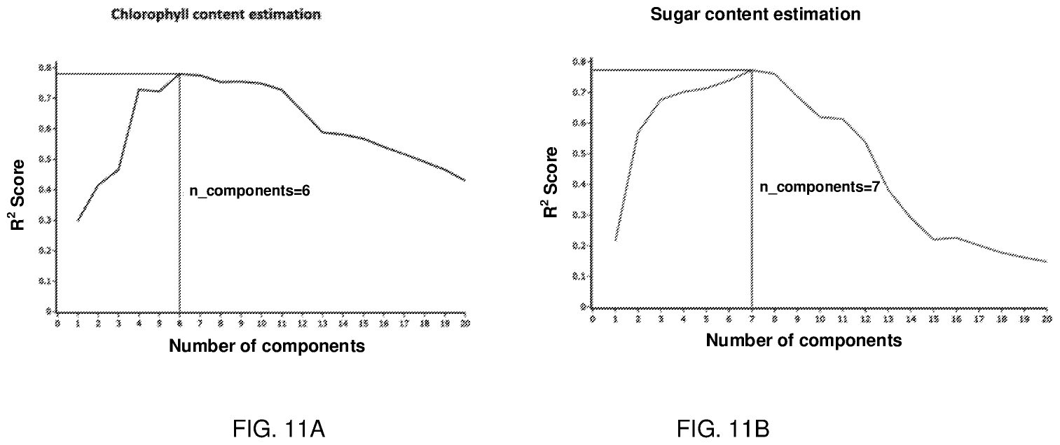

p. FIGS. 11A and 11B are graphs of the R² scores from a partial least-squares regression (PLSR) method versus numbers of PLSR components from 1 to 20 in examples for chlorophyll (11A) and sugar content (11B) respectively, with optimal numbers of components marked (n=6 for chlorophyll and n=7 for sugar).

### DETAILED DESCRIPTION

Described herein are a method and a system for automated hyperspectral vegetation index (VI) derivation, including based on a hyperparameter optimization (HPO) framework. The system and the method described herein may be referred to as the “automated vegetation index” (AutoVI) system and method. The AutoVI method and system can generate indices (e.g., “AutoVI-CI” and “AutoVI-SI” described hereinafter) that correlate strongly with corresponding traits of interest and outperform existing VIs by a significant margin.

Biochemical constituents in plants absorb electromagnetic (EM) energy in specific (i.e., pre-selected or defined) wavelength regions (referred to herein as “wavebands” or “bands”). These wavebands are each narrow and contiguous, and are mutually distinct, i.e., no two selected wavebands include exactly the same set of EM frequencies. The wavebands may be mutually exclusive and non-overlapping, i.e., no two selected wavebands include any of the same EM frequencies. Vegetation indices (VIs) profiled around these characteristic spectral (absorption) regions can detect or quantify a vegetation trait of interest. A VI model defining a VI is primarily needed to combine two or more wavebands to decipher certain biochemical or biophysical traits of interest. Development of a new VI requires selection of both a suitable model and set of wavebands. The AutoVI method and system is constructed to automate the identification of critical spectral regions using a hyperparameter optimization (HPO) framework. The term “hyperparameter optimization” (HPO) describes machine learning in which specific algorithms (described hereinafter) are deployed to select optimum values in a defined search space for model parameters (which are values learned from data) and hyperparameters (which are values associated with the model function or architecture) to maximize the model performance (Bergstra et al., 2011; Yu & Zhu, 2020). Using the HPO framework, the AutoVI system and method may provide end-to-end VI development, including steps of index model evaluation and optimum waveband selection with minimal user input.

The AutoVI system includes a module referred to herein as an “optimizer module”, or “optimizer”, configured to perform optimization steps.

The optimizer provides a meta-heuristics search algorithm that recovers the optimum solution (i.e., the optimum wavebands and coefficient values) from the predefined search space (as defined by the available hyperspectral input size and the coefficient value range, 0 to 1).

The optimizer may be configured to perform a Bayesian optimization method.

The optimizer may be a Bayesian optimizer, and may be a Tree-Structured Parzen Estimator (TPE) optimizer.

The AutoVI method and system create and access measured ground truth values of the vegetation trait in the plant of interest, e.g., measurements of wheat total chlorophyll content or total sugar content (examples are provided hereinafter), and respective measured spectra (e.g., reflectance spectra) of the plant of interest. The AutoVI system and method access data representing measured spectra and respective measured ground truth values of the selected vegetation trait (i.e., the plant trait of interest), e.g., from experimental measurements, e.g., as described hereinafter for sugar and chlorophyll.

The AutoVI method includes the following steps performed by the optimizer (e.g., as shown in FIG. 1):
a. a VI-model selection step;
b. a model parameter generation step;
c. a model parameter tuning step; and
d. a model evaluation step.

The VI-model selection step, the model parameter generation step, the model parameter tuning step and the model evaluation step are together referred to as the “optimization steps”. Performance of the optimization steps once each, in order, may be referred to as one “run” or a “single iteration” of the optimization steps.

The AutoVI method and system seek to generate a VI model for the desired trait based on a model evaluation metric, which is an objective function score (which may be R²) given time and computing resource constrains. Unlike simple optimization challenges which typically search for optimal solutions for a single model or function (static search space), multiple index models (dynamic search spaces) are optimized and evaluated in the AutoVI method and system. This is made possible by using dynamic parameter programming or “define-by-run” coding (e.g., see (Akiba et al., 2019)) which generates the search space or set of model parameters during code execution depending on the index model or equation under evaluation. The AutoVI method and system create and use a library of VI models. Each VI model includes a relationship defining an index value for the vegetation trait by mathematically combining spectral (e.g., absorption) measurement values (e.g., B1, B2, . . . , Bn) at a plurality of wavebands, i.e., at least two mutually distinct wavebands (referred to as “model wavebands”), optionally with one or more coefficients (e.g., alpha, beta, gamma, delta, rho, sigma, . . . , omega). The relationships of the VI models may define the index value by mathematically combining the spectral measurement values (e.g., B1, B2, . . . , Bn), optionally with the one or more coefficients, according to one or more mathematical operations including: subtraction, addition, division, logarithms (e.g., log_10), nth roots (e.g., square root), exponentials, and/or trigonometric operations (e.g., arctan). The coefficients (referred to as “model coefficients”) have each a value between zero and unity (0 to 1). The models are stored are computer-readable data and accessed by the optimizer, e.g., as shown in the computer code listing hereinafter, line 8.

The AutoVI method and system are methods and systems for automated hyperspectral vegetation index (VI) determination, i.e., selection and optimization, i.e., selection and tuning of the VI model, its wavebands and its coefficients for a selected vegetation trait. The vegetation trait represents characteristics or traits of interest in the plant, e.g., wheat total chlorophyll content, or total sugar content. The vegetation trait may be a biochemical trait, a physiological trait or a morphological trait. The vegetation trait may be total chlorophyll content (μg/g), or total sugar content, e.g., of wheat. The vegetation trait defines a numerical value that can be measured.

The method may include creating the library of VI models. In an example, a library of 33 VI models was created (manually) from many, e.g., 500, previously developed VIs (e.g., examples in TABLE 1), in which the previously developed VIs were of varying complexities, differing in the number of distinct wavebands (N_{wb}=2 to 6, i.e. B1, B2, . . . B6 in TABLE 1) and number of coefficients (N_{Cf}=1 to 5, i.e. α, β, . . . , ρ in TABLE 1).

TABLE 1 shows example index models in the library, wherein the index models are named (“model name”), and have a total number of wavebands (n_bands), and a total number of coefficients (n_coeff), grouped by the number of bands (“Group”):

| Model | | | | VI Model |
|---|---|---|---|---|
| Name | n_bands | n_coeff | Group | Relationship |
| 1 | 2 | 0 | M2 | (B1 − B2)/(B1 + B2) |
| 2 | 2 | 0 | M2 | (B1/B2) |
| 3 | 2 | 0 | M2 | B1 − B2 |
| 4 | 2 | 2 | M2 | α + β (B1 − B2)/(B1 + B2) |
| 5 | 2 | 1 | M2 | (B1/B2) − α |
| 6 | 2 | 0 | M2 | log(1/B1) − log(1/B2) |
| 7 | 2 | 0 | M2 | log(1/B1) + log(1/B2) |
| 8 | 2 | 3 | M2 | α [(B1 − αB2 − β)/(αB1 + B2 − α + ρ)] |
| 9 | 2 | 2 | M2 | B1 − α [B2/(B1 + β B2)] |
| 10 | 2 | 0 | M2 | {(B1/B2) − 1}/sqrt{(B1/B2) + 1} |
| 11 | 3 | 0 | M3 | (B1 − B2)/(B3 − B2) |
| 12 | 3 | 2 | M3 | α (β(B1 + B2) − B3) |
| 13 | 3 | 0 | M3 | B1(B2/B3\hat{ }2) |
| 14 | 3 | 0 | M3 | 2.B1 − B2 − B3)/(2.B1 + B2 + B3) |
| 15 | 3 | 0 | M3 | [(B1 − B2)/(B1 + B2)]/[(B1 − B3)/(B1 + B3)] |
| 16 | 3 | 1 | M3 | (B1 − B2 − α(B2 − B3))/(B1 + B2 − α(B2 − B3)) |
| 17 | 3 | 0 | M3 | (B1 − B2)/B3 |
| 18 | 3 | 0 | M3 | {B1 − (B2 + B3)}/{B1 + (B2 + B3)} |
| 19 | 3 | 0 | M3 | B1/(B1 + B2 + B3) |
| 20 | 3 | 2 | M3 | Arctan({(α.B1 − B2 − B3)/β}{B2 − B3}) |
| 21 | 3 | 4 | M3 | α[β(B1 − B2) − ρ(B3 − B2)]/sqrt[(2.B1 + 1)\hat{ }2 − |
| | | | | (γ.B1 − σ.sqrt(B3)) − α/3] |
| 22 | 4 | 0 | M4 | (B1/B2)/[(B3 − B4)/(B3 + B4)] |
| 23 | 4 | 0 | M4 | B1/(B2 + B3 + B4) |
| 24 | 4 | 0 | M4 | {(B1 + B2) − B3}/(B4 − B3) |
| 25 | 4 | 1 | M4 | [(B1 − B2) − α(B1 − B3)(B1/B2)]/[(1 + α)(B4 − |
| | | | | B2)/(B4 + B2 + α)] |
| 26 | 5 | 3 | M5 | [(B1 − B2) − α(B1 − B3)(B1/B2)]/[α{β(B4 − B3) − ρ(B2 − |
| | | | | B3)/sqrt((B4 + 1)\hat{ }2 − (B5 − ρ.2.sqrt(B2)) − 0.5)}] |
| 27 | 5 | 0 | M5 | B1/(B2 + B3 + B4 + B5) |
| 28 | 5 | 0 | M5 | (B1 − B2)/(B2 + B3 + B4 + B5) |
| 29 | 5 | 0 | M5 | {(B1 + B2) − B3}/(B4 − B5) |
| 30 | 6 | 0 | M6 | (B1*B2*B3)/(B4*B5*B6) |
| 31 | 6 | 0 | M6 | B1/(B2 + B3 + B4 + B5 + B6) |
| 32 | 6 | 0 | M6 | (B1 − B2)/(B2 + B3 + B4 + B5 + B6) |
| 33 | 6 | 1 | M6 | [(B1 − B2) − α(B1 − B3)(B1/B2)]/[(1 + α)(B4 − |
| | | | | B2)/(B4 + B2 + B5 + B6 + α)] |

In the model selection step (step 1, FIG. 1), the optimizer accesses the library and selects a VI model from the library of index models. This selection of the VI model can be a random selection based on a random number generator, optionally fixed using a seed number, i.e., specifying seed=123 to allow reproduction of results: e.g., as shown in the computer code listing hereinafter, lines 13 to 20. Multiple repetitions are used to mitigate the risk of a fixed seed or single run leading to a localized maxima (low score) simply because the Bayesian optimizer started searching in the wrong space and got stuck in the local maximum.

In the model parameter generation step, for the selected model, the optimizer generates the model parameters corresponding to the N_{wb} and N_{Cf} (step 2, FIG. 1). The model parameter generation step includes generating a model parameter for each of the spectral measurement values of the selected VI model, wherein the model parameter includes a waveband (e.g., “band1” defined in the measured data, e.g., the measurement made at “400 nm” which comprises a known waveband in the spectrometer) for each of the plurality of wavebands (selected based on the measured spectrum of the plant, i.e., the optimizer selects possible wavebands based on the input hyperspectral dataset, e.g., if input dataset contains 200 bands, the possible candidates are “band1” to “band200” (e.g., see the computer program listing, lines 20 to 36)). The model parameter generation step additionally includes generating a model parameter for each of the model coefficients of the selected VI model (if the selected VI model has any coefficients), wherein the model parameter includes coefficient value for each of the coefficients (e.g., 0 to 1, see the computer program listing, lines 38 to 54).

In the model parameter tuning step (step 3, FIG. 1), the optimizer selects the optimum (or “more optimum”) wavebands and coefficient values (between 0 and 1) for the selected model based on previous iterations of the optimization steps, i.e., the optimizer selects the waveband for each of the at least two wavebands (referred to as the “optimum wavebands”), and optionally selects the coefficient values for each of the coefficients (referred to as the one or more “optimum coefficient values”), by performing sequential model-based optimization (SMBO) in each iteration of the model parameter tuning step. The SMBO may be Bayesian SMBO, and the optimizer may be a Bayesian optimizer, and may be a Tree-Structured Parzen Estimator (TPE).

In the model evaluation step (step 4, FIG. 1), the optimizer evaluates the selected model based on, and in order to maximize, an objective function score. The objective function score quantifies a closeness of fit between the ground truth values and calculated VI values from the selected VI model with the generated model parameters and the respective measured spectra. The ground truth value of the vegetation trait may be, for example, the chlorophyll or sugar content or other trait of interest of the plant when the spectrum is being measured. The ground truth values are stored and accessed as data: e.g., as shown in the computer code listing hereinafter, line 7. The objective function score can be a coefficient of determination, R², derived from a linear regression fitted to calculated index values and the ground truth values. The coefficient of determination, R² (or “R2”), is known in the field of statistical model evaluation. The coefficient of determination (R2) is derived from a linear regression fitted to calculated index values from the selected VI model and the ground truth values, e.g., as shown in the computer program listing, lines 56 to 58. Alternatively, the objective function can use metrics other than R2 to quantify the closeness of the fit between the VI model and the ground truth measurements of the selected vegetation trait: e.g., the objective function may use other metrics including mean absolute error (MAE), mean average percentage error (MAPE), and root mean squared error (RMSE).

The method includes repeating the model selection step, the model parameter generation step, the model parameter tuning step and the model evaluation step (together referred to as the “optimization steps”) for a plurality of iterations (which is a selected number of iterations).

The AutoVI method and system repeats the optimization steps for the plurality of iterations until an end condition is reached, e.g., repeating the optimization steps until a pre-determined number of iterations is reached. At each iteration, a different index model may be selected, and new model parameters selected, and the computed objective function score (e.g., R²) is compared to the previous iteration(s). Additionally, unique sets of model parameters are computed for the respective index models. After each iteration, the optimizer may retain an index model which performs better (e.g., with a higher objective function score) compared to other candidate index models. The plurality of iterations seek to maximize the objective function score (e.g., R²), by selecting the best candidate model and an optimum set of model parameters.

The model evaluation step returns the value of the objective function (e.g., R2, e.g., as shown in the computer program listing, lines 11 to 58). The value of objective function informs the Bayesian optimizer on the next iteration how to select the VI model (in the model selection step), and how to select the selected wavebands (e.g., “band1”, “band200”) and optionally the selected coefficient values (in the model parameter generation step). With each iteration, the objective function score is used to establish a probability distribution of “good” model parameter values. The model evaluation step is a dedicatedly defined step to guide the optimizer in identifying the best performing models. Each iteration repeats the model selection step, the model parameter generation step (including the model parameter tuning using the Bayesian optimizer), and the model evaluation step. The Bayesian optimizer works by selecting an index model, optimizing the bands and coefficients, and generating an objective function value in the first iteration. The optimization steps are repeated until the Bayesian optimizer determines a measure of which model tends to perform better and which sets of model parameters give better performance for that model: in other words, the Bayesian optimizer builds a probability distribution of “good” models and “good” model parameter values (with “good” defines by optimization of the objective function—e.g., R2 derived from a linear regression fitted to calculated index values from the selected VI model and the ground truth measurements of the vegetation trait, i.e., closeness to the measured index values. In the initial iterations, the model selection can be random, using a random number generator for model selection, and the waveband and coefficient selections can be random, using a random number generator. In subsequent iterations, the Bayesian optimizer, now having determined which models and model parameters tend to perform better, progressively focuses on the best model. For example, in an experiment of 20,000 iterations, for the first 1,000 iterations, the Bayesian optimizer may just sample repeatedly and randomly the index models in the library to get an idea of the baseline performance these models provide based on the objective function score; then for the next 5,000 iterations, the Bayesian optimizer may focus on a few models which performed better by repeatedly sampling them only and attempting to further optimize the model parameter values; and finally, for all the remaining 14,000 iterations, the Bayesian optimizer may just settle on one single best model and focus on getting the best model parameter value for that model. Thus by the end of 20,000 iterations, the Bayesian optimizer can return the one best model with the best model parameter values. The selected number of the iterations (also referred to as “runs”) may be between 100 and 100 million, or between 1,000 and 1 million runs, or between 10,000 and 200,000 runs, or between 10,000 and 60,000 runs, or around 20,000 runs, depending on the complexity of the hyperspectral data (e.g., the number of waveband bands in the input data). The AutoVI method and system may include around 20,000 optimization runs. Experimental examples for wheat total chlorophyll content, described hereinafter, show that performance from 20,000 and 60,000 iterations were similar (R²=˜0.8).

The AutoVI method and system selects the VI model with the selected optimum wavebands and optimum coefficient values, i.e., the VI model with model parameters that generates the highest object function score over all iterations (“runs”).

As mentioned hereinbefore, the optimizer may be a Tree-Structured Parzen Estimator (TPE) optimizer (Bergstra et al., 2011; Yu & Zhu, 2020), which may show better accuracy and efficiency compared to other optimizers when dealing with dynamic search spaces (Bergstra et al., 2015; Akiba et al., 2019; Yu & Zhu, 2020). The TPE optimizer may be a highly performant hyperparameter optimizer for the AutoVI system and method. The TPE optimizer implements a variant Bayesian optimization approach that tries to construct a probabilistic model, also known as a “surrogate” model, for mapping hyperparameters based on the probability of an objective function score given the set of hyperparameters, p(y|x), according to the following equation:

$$p ( y \vert x ) = \frac{p ( x \vert y ) * p ( y )}{p ( x )}$$

where y is the objective function score given x, and x the set of hyperparameters.

The TPE optimizer determines the probability of hyperparameters given the objective function score, p(x|y), using the following tree-structured equation:

$$p ( x \vert y ) = \{ \begin{matrix}l ( x ) if y < {y}^{*} \\ g ( x ) if y \geq {y}^{*}\end{matrix}$$

where y* is a threshold dividing the hyperparameters into two distributions: l(x), where the objective function score y is less than the threshold; g(x), where the objective function score y is greater than the threshold.

The TPE optimizer maximizes the expected improvement in the objective function score in successive hyperparameter samplings, which is defined by a function proportional to the ratio of l(x)/g(x) (Bergstra et al., 2011; Yu & Zhu, 2020), that is, the TPE optimizer samples hyperparameters from the l(x) distribution, evaluates them in terms of l(x)/g(x), and returns the set of hyperparameters that yields the greatest expected improvement.

The AutoVI method and system may generate novel VI models with a coefficient in the index equation, e.g., alpha (a), beta, gamma, delta, rho, sigma, . . . , omega. The coefficient or coefficients may have a positive and stabilizing effect on model performance across multiple computational repetitions, e.g., good stability has been demonstrated in examples over 3 to 10 or more repetitions. The coefficient may allow for fine-tuning of the VI model and potentially account for physical factors (e.g., background, soil effects, moisture etc.) besides vegetation that could affect the index value (Xue & Su, 2017), noting that soil-adjusted VIs such as SAVI (Huete, 1988), MSAVI (Qi et al., 1994) and OSAVI (Rondeaux et al., 1996) have previously been modified from NDVI through the introduction of coefficients, termed soil adjustment factors, to account for the effect of soil brightness on index values.

The AutoVI method and system may generate trait-specific novel VI models including more than 2 wavebands, e.g., 3, 4, or more wavebands. A feature of the AutoVI method and system may be the ability to optimize VI models with more than 2 wavebands (including more than 3, more than 4, more than 5, or more than 6), which may be intractable with prior VI model selection techniques due to the curse of high dimensionality. For example, prior approaches to generate novel hyperspectral VIs used single or multiple correlation matrices between VI pairs and the trait of interest to uncover new band or index combinations (Thenkabail et al., 2004; Aasen et al., 2014; Xu et al., 2019), but these approaches are computationally expensive as every possible combination of available bands (filtered or unfiltered) needs to be computed. The AutoVI method and system may generate trait-specific novel VI models with more than 2 wavebands (including more than 3, more than 4, more than 5, or more than 6) without requiring band filtering and/or dimension reduction techniques to limit the number of input hyperspectral bands prior to processing.

The method may additionally include:
a. a grouping step, including grouping VI models from the library according the number (N_{wb}) of the distinct model wavebands, including a first group with a plurality of two-waveband models (N_{wb}=2) and a second group with a plurality of three-waveband models (N_{wb}=3);
b. a running step, including determining the best-performing VI model within each group by a plurality of iterations (“runs”) of the optimization steps for each group; and
c. a cross-group comparison step, including selecting an overall best VI model from the best-performing VI models (based on their respective objective function scores).

To mitigate selection bias towards models with lower complexities (N_{wb}≤3), a feature of the AutoVI method and system is grouping the VI models according to N_{wb}, i.e., similar complexity, and determining the best-performing VI model within each group. One possible issue with any optimization system is its potential to exhibit selection bias towards index models with lower complexity, e.g., models with N_{wb} between 2 and 3 compared to those with higher complexity, e.g., models with N_{wb} between 4 and 6, because the size of the solution search space increases exponentially with the increase in the number of input features, i.e., N_{wb} (Winston, 1992; Yao & Liu, 1997), which is linked to the curse of dimensionality (Hinneburg & Keim, 1999; Bajwa & Kulkari, 2011; Burger & Gowen, 2011). Consequently, complex models (N_{wb}≥4) require more computational time or resource to attain comparable objective scores (R²) relative to simpler models (N_{wb}≤3). When all model computations are grouped together, simpler models tend to outperform complex models leading towards a ‘locally maximal solution’, which is the tendency of the computation to get stuck at a sub-optimal solution (Hinneburg & Keim, 1999). To address this issue, the AutoVI method and system perform computations on model groups consisting of models with the same N_{wb}: the AutoVI method and system can include a plurality of parallel instances, i.e., a plurality of optimizers (i.e., multiple copies or instances of the method) operating in parallel, one instance for each N_{wb} in the index models in the library: for example, five parallel instances for N_{wb} from 2 to 6, as shown in FIGS. 2A and 2B, of the optimizer, corresponding to the plurality of model groups (M2, M3, . . . M6, equivalent to N_{w}=2, 3, . . . 6), may execute with a plurality of iterations (e.g., 20,000 iterations) each with the optional coefficients fixed at 1. Also as shown in FIGS. 2A and 2B, the AutoVI method can include a plurality of repetitions of the iterations (e.g., 5 repetitions as shown in FIGS. 2A and 2B), e.g., the computations of the iterations may be repeated five times (on the train-test split datasets), with the best performing index model from each group logged at each run. Performing the plurality of repetitions can find the best-performing model within each model group, and performing the plurality of parallel instances can find the overall best model across groups, while circumventing model selection bias. To evaluate the grouped model approach (i.e., including the plurality of parallel instances), results from performing the plurality of parallel instances were compared to results obtained without any grouping (referred to as “No Group” in FIG. 2A).

The method may include analysis of samples of the plant to generate the spectral measurements of the plant and the corresponding ground truth values. The method may include using a hyperspectral imaging sensor or spectrometer to generate the spectral measurements. The method may include imaging plants in three different angles (0°, 120°, and 240°), with the plants being rotated to the angles using a lifter and turner assembly.

The at least two wavebands include a plurality of different wavebands selected from the visible (VIS, 400-700 nm), near infrared (NIR, 700-1000 nm) and shortwave infrared (SWIR, 1000-2500 nm) regions. The wavebands may be selected from the shortwave infrared (SWIR) region spanning 1200-1700 nm, in particular around 1410-1430 nm and 1550-1680 nm. The wavebands may be selected from the near infrared (NIR) region spanning 800-900 nm. The wavebands may include a plurality of measured wavebands in the range 400 nm to 5,400 nm, e.g., over 1,000 wavebands, over 2,000 wavebands, over 3,000 wavebands, over 4,000 wavebands, or over 5,000 wavebands, based on the number of wavebands in the spectral measurements from the hyperspectral imaging sensor or spectrometer.

The system includes an optimizer module (or “optimizer”) configured to perform the optimization steps, including the model selection step, the model parameter generation step and the model evaluation step.

The system may include: one or more hyperspectral sensors, optionally mounted to an unmanned aerial vehicle (UAV) system.

The system may include: a hyperspectral imaging station (including a sensor or spectrometer) to generate the spectral measurements; and a lifter and turner assembly for imaging plants in three different angles (0°, 120°, and 240°) to generate the spectral measurements of the vegetation trait. The hyperspectral imaging station may include a pushbroom-type imaging spectrometer operational over a spectral range of 475-1710 nm and a spectral resolution of less than 10 nm.

The AutoVI method may include using the determined “optimal” VI model, with its optimum wavebands and optimum coefficient values, to calculate a VI value from a measured spectrum, including from the one or more hyperspectral sensors, optionally mounted to an unmanned aerial vehicle (UAV) system.

The AutoVI system includes at least one computing processor and computer-readable memory that are together configured to perform the method. Machine-readable storage media may be configured to include machine readable instructions that, when executed by a computing system, perform the data-processing steps of the method, including at least the optimization steps. The machine-readable storage media is configured to include the machine readable instructions. The machine readable instructions are computer-executable instructions that, when executed by at least one processor, cause the at least one processor to perform a set of operations comprising the method. Exemplary machine readable instructions include instructions compiled from the code in the computer program listing hereinafter.

The AutoVI method and system may provide an efficient and flexible tool for deriving accurate hyperspectral VIs for plant phenotyping, e.g., delivering superior performance compared to existing VIs for chlorophyll and sugar content estimation in wheat. Compared to popular machine learning approaches where model deployment remains technically challenging, the indices from the AutoVI method and system can be easily computed and readily deployed for high-throughput plant phenotyping without requiring complex hardware or software resources. In addition, the AutoVI method and system do not impose any size or dimensional constraints on the input data and may work with data derived from different hyperspectral sensors. Depending on the data provided, the AutoVI method and system can be customized to deliver specific VIs for the trait of interest according to species, growth stage and environment. The AutoVI method and system may accelerate the development of novel VIs for plant/crop traits which will find wide application in high-throughput phenotyping (HTP) and agriculture remote sensing vital to improving breeding programs and crop management efficiencies.

As described hereinafter, to demonstrate the efficacy of the AutoVI system and method in generating new trait-specific VIs, example novel VIs derived from the AutoVI system and method delivered superior performance compared to prior existing VIs for chlorophyll and sugar content estimation in wheat. Compared to previous machine-learning approaches where model deployment remains technically challenging, the VIs described herein may be computed easily and deployed readily for high-throughput plant phenotyping and/or agriculture remote sensing without additional complex hardware or software resources.

### Experimental Examples

An example AutoVI system and method, including the optimizer customised to handle hyperspectral data, was implemented in the Python 3.7 environment using the open source hyperparameter optimization library, Optuna version 2.0 (Akiba et al., 2019) with default settings. A graphical user interface (GUI) for the example AutoVI system and method was implemented in Python. The example AutoVI system and method was implemented and tested on an AMD Threadripper 3970X (32-cores) system with 256 GB RAM at SmartSense iHub, Agriculture Victoria, Australia. Exemplary source code of the example AutoVI system and method is included hereinafter in the computer program listing, including explanatory comments preceded with hashtags “#”.

Experimental data were collected in a high-throughput controlled-environment phenotyping facility in Plant Phenomics Victoria, Horsham (PPVH), Agriculture Victoria, Australia, as previously described (Banerjee et al., 2020). The PPVH facility is equipped with a conveyor belt system, automated weighing and watering stations, and an automated phenotyping Scanalyzer 3D system (LemnatecGmBH, Aachen, Germany), which includes a hyperspectral imaging sensor. For the experiment conducted at the PPVH, plants (e.g., the wheat variety Yitpi) were grown with 20, 10, 5, and 2 mM nitrogen (N) levels. One plant was grown per pot in a nutrient-free growth medium, consisting of perlite covered with a layer of vermiculite. Individual pots were weighed and equalized to a fixed pot weight and watered uniformly. The pots were loaded onto the system 10 days after the emergence of seedlings. Nutrient solution (4 mM MgSO₄, 4 mM KCl, 5 mM CaCl₂, 3 mM KH₂PO₄/K₂HPO₄—pH 6.0, 0.1 mM Fe-EDTA, 10 μM MnCl₂, 10 μM ZnSO₄, 2 μM CuSO₄, 50 μM H₂BO₃, and 0.2 μM Na₂MoO₄) with the indicated N concentration was supplied as 100 ml per pot every week. The growing conditions were 16 h (24° C.) day/8 h (15° C.) night. The experiment was conducted as biological repeats with 20 replicate plants per N treatment. A subset of five plants per N treatment were destructively harvested at 14, 21, 28 and 35 days after sowing (DAS) and a total of 80 samples were collected for biochemical assays, i.e., to measure the ground truth values: this dataset (n=80) was randomly split 65:35 into training and test datasets, with both datasets having the same sample distribution (i.e., stratified sampling) according to time points, and the resulting train-test split was used for subsequent AutoVI computations and regression modelling for chlorophyll content prediction described herein, thus the AutoVI system was trained on the training dataset to derive novel indices for chlorophyll content estimation, with the performance of these indices validated using the test dataset.

Plant tissue was finely ground using a pestle and mortar with liquid N, then subsampled separately for chlorophyll analysis and sugar analysis (e.g., aliquoted into 50 mg (for chlorophyll analysis) and 100 mg (for sugar analysis) subsamples), and stored at −80° C. until biochemical analysis. Chlorophyll was extracted with 100% methanol followed by centrifugation for 10 min at 10,016 g; this process was repeated twice. Extracts were analyzed by recording the absorbance at 750, 665, 652, and 470 nm using a UV-VIS spectrophotometer (Shimadzu UV-1800, Shimadzu Inc., Kyoto, Japan). Total chlorophyll (μg/g) was calculated using the formula described in Lichtenthaler (1987), and ranged between 396.2 and 821.9 μg/g. For sugar analysis, sugar was extracted with 80% (v/v) ethanol followed by centrifugation for 10 min at 10,016 g; this process was repeated twice. Extracts were analyzed by recording the absorbance at 620 nm and total sugar (μg/g) was determined using the anthrone method as described in Yemm and Willis (1954); alternatively, total soluble sugars were assayed according to a colorimetric method as described in DuBois et al. (1956) and ranged between 2600 and 28300 μg/g.

To measure the plant spectra (corresponding to the ground truth values), the plants were scanned in a hyperspectral imaging station equipped with a pushbroom-type imaging spectrometer (e.g., from Micro-Hyperspec, VNIR-E Series, Headwall Photonics, Fitchburg, MA, USA). The sensor was operational over a spectral range of 475-1710 nm (the green-red portion of VIS, the entire NIR, and the first part of SWIR) with a spectral resolution of less than 10 nm (about 4.85 nm) to acquire a 256-band hypercube. Plants were imaged in three mutually different side view angles (0°, 120°, and 240°), with the pots rotated in distinct imaging angles using a lifter and turner assembly. The hyperspectral raw data was acquired in digital numbers (DNs) of 12-bit radiometric depth. Spectral and radiometric calibration of the hyperspectral sensor was performed to transform raw DN values into physical radiance units (mW cm² sr⁻¹ μm⁻¹) and then to radiance. The calibration was performed using an optically flat spectralon panel (https://www.labsphere.com/) as white reference. Additionally, a dark spectrum was collected with the halogen lamps turned off Sensor gain and bias transformation were automatically calculated and applied using a data-acquisition software (Hyperspec III, Headwall Photonics, Inc) to produce a radiometrically calibrated response. Flat-field errors (inter-channel mismatch) caused by pixel-to-pixel variation in sensitivity in the detector was also removed in the process. An automatic low-rank and sparse modelling technique (Rasti et al., 2017) was used to further remove inter-channel variation and radiometric bit error at given pixels. Spatial and temporal illumination variation in hyperspectral scenes were removed using an adaptive illumination adjustment algorithm (Banerjee et al., 2020). In addition, a spectrum elimination technique was used to selectively avoid the inclusion of non-plant (cage, pot, soil, and background) class pixels, thereby detecting both the healthy and the stressed plant tissue (Banerjee et al., 2020): non-plant pixels (cage, pot, soil, and background) in the hyperspectral image were first classified using a spectral information divergence method (e.g., from Chein, 1999) and a binary mask was applied to segment out the remaining pixels (i.e., the plant pixels). The detected plant pixels from the imaged hypercube were averaged to generate a representative reflectance spectrum with 256 spectral bands. The reflectance spectrum was filtered and spectrally sampled to a spectral width of 1 nm, as required by the targeted VIs, using a linear resampling approach based on a generalized Kaiser-Bessel approximation model (e.g., from Lewitt, 1990). A total of 46 or 47 possible standard VIs within the operational spectral range of the hyperspectral system (475-1710 nm) were then computed (e.g., including the 46 in TABLE 7).

### Chlorophyll Content Estimation

In an example, the AutoVI method and system were used to derive high quality novel hyperspectral VIs for plant phenotyping using wheat total chlorophyll content (μg/g) as a biochemical trait. Chlorophyll content, either measured or estimated, can be a direct indicator of a plant's primary production and has been used to determine the nitrogen (N) status and stress response of crop plants (Richardson et al., 2002; Murchie & Lawson, 2013). A previous hyperspectral VI, the NDCI_{w}, for estimating chlorophyll levels (Banerjee et al., 2020) provided a benchmark to measure model performance and quality of the AutoVI method and system.

The best VI model generated using the AutoVI method was compared to NDCI_{w} using R² scores computed for individual (and across) wheat growth time points (14, 21, 28 and 35 days after sowing, DAS).

In a first chlorophyll content estimation example, the best index models obtained from the grouped model evaluations in AutoVI showed high correlations (R²=0.76-0.79) to the total chlorophyll content (as shown in FIG. 3A and in TABLE 2).

TABLE 2 shows best-performing index models from grouped model evaluations for total chlorophyll content estimation, wherein AutoVI computations were performed on index models grouped according to N_{wb}, the best model from each group was identified from five repeated computations, the overall best R2 score is that of “model25”, and wherein the coefficient(s) in the Formula are set to the value of 1:

| | | | Selected | |
|---|---|---|---|---|
| | | | W′length | |
| Group | Model | Formula | (nm) | R² |
| All | model 15 | [(B1 − B2)/ | B1: 756, | 0.7710 |
| | | (B1 + B2)]/ | B2: 638, | |
| | | [(B1 − B3)/ | B3: 710 | |
| | | (B1 + B3)] | | |
| M2 | model5 | (B1/B2) − α | B1: 712, | 0.7663 |
| | | | B2: 636 | |
| M3 | model11 | (B1 − B2)/ | B1: 716, | 0.7768 |
| | | (B3 − B2) | B2: 1712, | |
| | | | B3: 606 | |
| M4 | model25 | [(B1 − B2) − | B1: 496, | 0.7993 |
| | | α(B1 − B3)(B1/ | B2: 1274, | |
| | | B2)]/ | B3: 712, | |
| | | [(1 + α)(B4 − B2)/ | B4: 609 | |
| | | (B4 + B2 + α)] | | |
| M5 | model26 | [(B1 − B2) − | B1: 1126, | 0.7969 |
| | | α(B1 − B3)(B1/ | B2: 623, | |
| | | B2)]/ | B3: 1234, | |
| | | [α{β(B4 − B3) − | B4: 713, | |
| | | ρ(B2 − B3)/ | B5: 1087 | |
| | | sqrt((B4 + 1)\hat{ }2 − | | |
| | | (B5 − | | |
| | | ρ.2.sqrt(B2)) − | | |
| | | 0.5)}] | | |
| M6 | model30 | (B1*B2*B3)/ | B1: 987, | 0.7784 |
| | | (B4*B5*B6) | B2: 667, | |
| | | | B3: 715, | |
| | | | B4: 683, | |
| | | | B5: 613, | |
| | | | B6: 1165 | |

The overall best VI model (model25), termed hereinafter “AutoVI chlorophyll index” (AutoVI-CI), produced a R² of 0.7993 with N_{wb}=4 and N_{Cf}=1 (as shown in FIG. 3A). The best index model selected when no groupings were applied was a 3-bands index model (model15, N_{wb}=3), suggesting that the optimizer may have exhibited a selection bias towards models with lower complexity (N_{wb}≤3) when all 33 index models were considered within the one group. The second-best index model, model26 (N_{wb}=S, N_{Cf}=3) had a R² of 0.7969, followed by model30 (N_{wb}=6) with R² of 0.7784, model11 (N_{wb}=3) with R² of 0.7768 and finally model5 (N_{wb}=2, N_{Cf}=1) with R² of 0.7663 (as shown in FIG. 3A and in TABLE 2). In some examples, the wavebands selected for the best index models in each respective model group fell predominantly within the visible (VIS) region spanning 600-750 nm, with a few bands coming from the extended visible-near infrared (VNIR) region spanning 1000-1200 nm (as shown in FIG. 4A and in TABLE 2). The best R² score produced by AutoVI-CI was achieved using wavebands of 496 nm, 609 nm, 712 nm and 1274 nm (as shown in TABLE 2).

To evaluate the effect of longer optimizations, i.e., larger numbers of iterations, iterations with the same index model were conducted for 60,000 iterations across 10 repetitions. Longer optimizations, at least up to 60,000 iterations (˜4 hours for 5 repetitions) did not result in significantly better performance compared to shorter optimizations such as with 20,000 iterations (˜1.25 hours for 5 repetitions). The best R² scores for AutoVI-CI (without the alpha (a) coefficient mentioned hereinafter) did not differ much between that of 20,000 iterations (R²=0.7993) and 60,000 iterations (R²=0.8009). The effect of longer optimizations and inclusion of coefficients on model performance may be determined using the overall best index model, e.g., with a plurality of repeated AutoVI computations (e.g., five) at 20,000 and 40,000 iterations with and without coefficient tuning. To determine the quality of AutoVI-derived indices for chlorophyll estimation, they were used as features in simple linear regression (SLR) modelling to predict chlorophyll content. SLR with each of the derived indices was first trained on the training dataset and then used to predict chlorophyll values for the test dataset. Model performance was evaluated using the R² score calculated between predicted and actual chlorophyll values for the test dataset. In addition, performance for a stepwise multiple linear regression (SMLR) method (described hereinafter) with VIs selected from 25 AutoVI-derived indices (FIG. 2B) was included. Results achieved using AutoVI-indices were compared to those produced by SLR and SMLR with 46 or 47 published VIs, in addition to results provided by a PLSR method (described hereinafter) using the full spectrum of reflectance values, i.e., reflectance values from all 1,235 wavebands. For comparison across different regression models, additional performance metrics such as root mean squared error (RMSE), mean absolute error (MAE) and mean absolute percentage error (MAPE) may be determined.

To evaluate the effect of the coefficients on model performance, iterations with the same index model were conducted with and without the coefficient value(s) fixed at 1 across 10 repetitions. The AutoVI-CI performed better and was more consistent across the 10 computational repetitions when a coefficient variable, alpha (a) was allowed in its equation. A much shorter boxplot (min=0.7868, median=0.7990, max=0.8089) for R² scores obtained with the coefficient was observed compared to a taller boxplot (min=0.7384, median=0.7789, max=0.8009) for R² scores without the coefficient variable (as shown in FIG. 5A and in TABLE 3). This suggests that the inclusion of a coefficient variable had an overall positive and stabilizing effect on model performance. The optimized AutoVI-CI with coefficient α=0.1528, as depicted in the following equation, was evaluated against NDCI_{w} for total chlorophyll content estimation:

$$AutoVI - CI = \frac{( {R}_{651} - {R}_{607} ) - 0.1528 ( {R}_{651} - {R}_{728} ) \frac{{R}_{651}}{{R}_{607}}}{( 1 + 0.1528 ) \frac{( {R}_{691} - {R}_{607} )}{( {R}_{691} + {R}_{607} + 0.1528 )}}$$

where R_{wb} represent the reflectance measured at a discrete waveband (wb).

TABLE 3 shows effects of coefficient tuning on AutoVI-CI performance, including 10 repetitions (rep) each with 60,000 iterations with either the coefficient fixed at 1.0 (coefficient=No) or not fixed (coefficient=Yes), and the best R² score (0.8089) was that of rep7 with a variable coefficient:

| | | Selected | Coefficient | |
|---|---|---|---|---|
| Coefficient | Rep | Wavelength (nm) | Value | R² |
| No | rep1 | B1: 683, B2: 708, | α = 1.0 | 0.7886 |
| | | B3: 609, B4: 1156 | | |
| No | rep2 | B1: 1530, B2: 612, | α = 1.0 | 0.7633 |
| | | B3: 712, B4: 544 | | |
| No | rep3 | B1: 639, B2: 1214, | α = 1.0 | 0.7692 |
| | | B3: 1712, B4: 718 | | |
| No | rep4 | B1: 940, B2: 635, | α = 1.0 | 0.7384 |
| | | B3: 1287, B4: 722 | | |
| No | rep5 | B1: 1414, B2: 1382, | α = 1.0 | 0.7945 |
| | | B3: 716, B4: 610 | | |
| No | rep6 | B1: 592, B2: 1712, | α = 1.0 | 0.8007 |
| | | B3: 713, B4: 610 | | |
| No | rep7 | B1: 495, B2: 1311, | α = 1.0 | 0.8009 |
| | | B3: 712, B4: 610 | | |
| No | rep8 | B1: 638, B2: 1229, | α = 1.0 | 0.7687 |
| | | B3: 1712, B4: 718 | | |
| No | rep9 | B1: 733, B2: 1115, | α = 1.0 | 0.7907 |
| | | B3: 715, B4: 609 | | |
| No | rep10 | B1: 686, B2: 711, | α = 1.0 | 0.7650 |
| | | B3: 578, B4: 1384 | | |
| Yes | rep1 | B1: 1712, B2: 714, | α = 0.6180 | 0.7974 |
| | | B3: 622, B4: 1244 | | |
| Yes | rep2 | B1: 749, B2: 722, | α = 0.4127 | 0.8010 |
| | | B3: 607, B4: 752 | | |
| Yes | rep3 | B1: 584, B2: 705, | α = 0.3128 | 0.8000 |
| | | B3: 684, B4: 730 | | |
| Yes | rep4 | B1: 1711, B2: 714, | α = 0.5766 | 0.7968 |
| | | B3: 622, B4: 1340 | | |
| Yes | rep5 | B1: 715, B2: 1410, | α = 0.0010 | 0.7868 |
| | | B3: 1028, B4: 608 | | |
| Yes | rep6 | B1: 577, B2: 706, | α = 0.3879 | 0.7947 |
| | | B3: 678, B4: 1246 | | |
| Yes | rep7 | B1: 651, B2: 607, | α = 0.1528 | 0.8089 |
| | | B3: 728, B4: 691 | | |
| Yes | rep8 | B1: 1712, B2: 711, | α = 0.5374 | 0.8040 |
| | | B3: 618, B4: 723 | | |
| Yes | rep9 | B1: 679, B2: 652, | α = 0.8823 | 0.7979 |
| | | B3: 612, B4: 724 | | |
| Yes | rep10 | B1: 646, B2: 607, | α = 0.0809 | 0.8074 |
| | | B3: 736, B4: 681 | | |

When observed across the entire set of time points, AutoVI-CI with the variable coefficient showed stronger correlation (R²=0.8089) to the total chlorophyll content than NDCI_{w} (R²=0.5925, as shown in FIGS. 6A and 6B). In addition, when observed specifically at individual time points, AutoVI-CI with the variable coefficient outperformed NDCI_{w} by producing an acceptable level of correlation at very early stage of plant development (14 DAS, R²=0.736), with the correlation increasing thereafter (R²>0.8) and peaking at 35 DAS(R²=0.913)(as shown in FIG. 7). In contrast, NDCI_{w} had a very low correlation with measured chlorophyll levels at the early growth period (14 DAS, R²=0.203), with the correlation increasing thereafter (R²>0.7) and peaking at 35 DAS(R²=0.922)(as shown in FIG. 7). In other words, AutoVI-CI correlated strongly (R²=0.74-0.91) with total chlorophyll content at individual wheat growth periods (early to late vegetative) and across the entire growth period (R²=0.81). From these results, AutoVI-CI with the variable coefficient, compared to NDCI_{w} for chlorophyll content estimation, correlates strongly with measured chlorophyll levels at both individual time points and across the entire wheat growth period.

For chlorophyll, the selected wavebands centered around 600-750 nm within the VIS region with additional bands from the extended VNIR region (1000-1200 nm). This is consistent with published studies where most of the VIs for chlorophyll estimation used wavebands within the 400-860 nm region (Gitelson et al., 2005; Croft et al., 2017). In addition, the inclusion of bands from the extended VNIR region likely enhanced the index model's sensitivity towards chlorophyll, as was observed in the development of NDCI_{w}(Banerjee et al., 2020).

In a second chlorophyll content estimation example, AutoVI performance was measured using R² scores generated by simple linear regression models on the test dataset with the respective AutoVI-derived indices as features. AutoVI performance across five repetitions was relatively stable, with the grouped evaluation strategy allowing for comparison across different model groups and identification of the best performing index model within each model group (FIG. 3B). Between model groups, the M4 group (N_{wb}=4) had the best mean R² of 0.7818, followed by M5 (N_{wb}=5) with R² of 0.7747, M6 (N_{wb}=6) with R² of 0.7689, M2 (N_{wb}=2) with R² of 0.7637 and finally M3 (N_{wb}=3) with R² of 0.7555. Overall, model number 25 (Index25, N_{wb}=4, N_{cf}=1) produced the best VI (R²=0.8007) and generated the best results across all five repetitions within the M4 group (FIG. 3B). The performance of the best VIs according to model group is summarized in TABLE 4. Wavebands selected by AutoVI for the best chlorophyll indices derived predominantly from the red (600-720 nm) and red-edge (720-780 nm) regions, with a few wavebands from the blue (470-490 nm), near infrared (NIR, 1000-1300 nm) and shortwave infrared (SWIR, 1600-1700 nm) regions (see TABLE 4). The R² score produced by the best VI, termed hereafter as AutoVI chlorophyll index (“AutoVI-Chl”), was achieved using wavebands of 610 nm, 716 nm, 1384 nm and 1607 nm, without coefficient tuning (i.e., value set to 1), as depicted in the following equation, where R_{wb} represent the reflectance measured at a discrete waveband (wb):

$$AutoVI - ChI = \frac{( {R}_{1607} - {R}_{1384} ) - ( {R}_{1607} - {R}_{716} ) \frac{{R}_{1607}}{{R}_{1384}}}{( 2 ) \frac{( {R}_{610} - {R}_{1384} )}{( {R}_{610} + {R}_{1384} + 1 )}}$$

TABLE 4 shows performance of the best AutoVI-derived indices according to model group for chlorophyll estimation, including performance metrics calculated for simple linear regression using the indicated AutoVI-derived index for chlorophyll estimation on the test dataset with best scores indicated in bold:

| | | Selected | | | | |
|---|---|---|---|---|---|---|
| | Index | Wavelengths | | | | |
| Group | Model | (nm) | R² | RMSE | MAE | MAPE |
| M2 | 2 | 637, 711 | 0.7683 | 41.52 | 33.78 | 5.14% |
| M3 | 15 | 607, 716, 1712 | 0.7629 | 42.01 | 34.27 | 5.23% |
| M4 | 25 | 610, 716, 1384, | 0.8007 | 38.52 | 30.51 | 4.69% |
| | | 1607 | | | | |
| M5 | 26 | 497, 650, 707, | 0.7813 | 40.35 | 32.74 | 5.13% |
| | | 778, 1017 | | | | |
| M6 | 32 | 477, 635, 713, | 0.7776 | 40.69 | 33.01 | 5.03% |
| | | 1033, 1035, 1668 | | | | |

The performance of the AutoVI-Chl with or without a coefficient variable, alpha (a), as depicted in its original equation (model 25, “Index25”, TABLE 1) was determined across five computational repetitions of 20,000 and 40,000 iterations (FIG. 4B). At 20,000 iterations, the inclusion of the coefficient had minimal impact on AutoVI-Chl performance, as boxplots for R² scores obtained with the coefficient (min=0.7657, median=0.7771, max=0.7959) and without the coefficient (min=0.7673, median=0.7875, max=0.7922) were comparable (FIG. 4B). However, AutoVI computational time when the coefficient was included (˜2.1 hours for 5 repetitions) was up to 1.6× higher than without the coefficient (˜1.3 hours for 5 repetitions), suggesting that inclusion of coefficient(s) in AutoVI optimizations may likely incur computational costs. At 40,000 iterations, AutoVI-Chl performance deteriorated significantly with or without the coefficient (FIG. 4B), suggesting that overfitting, where a model performs significantly better on the training (i.e., overfitted) but not the test dataset (i.e., unable to generalize to new data), may be a concern with longer AutoVI runs. The effect of coefficients and longer AutoVI runs can be determined for individual target traits.

The quality of the AutoVI-derived indices for chlorophyll content estimation were evaluated further against 47 published VIs, as features in simple linear regression (SLR) modelling. First, the best SLR model resulting from AutoVI-indices and the best SLR model with existing VIs was compared (TABLE 5). The model with AutoVI-Chl (R2=0.8007, RMSE=38.52, MAE=30.51, MAPE=4.69%) significantly outperformed the model with the normalized difference chlorophyll index, NDCI (R2=0.6018, RMSE=54.45, MAE=46.05, MAPE=7.09%) (TABLE 5, S3). Next, stepwise multiple linear regression (SMLR) models using the optimum subset of features selected from AutoVI-indices and existing VIs were compared (TABLE 5). For the existing VIs, SMLR with 7 VIs selected led to a significant improvement in model performance (R2=0.7136, RMSE=46.17, MAE=38.12, MAPE=5.88%) compared to SLR with NDCI, but was still inferior to SLR with AutoVI-Chl; SMLR with four AutoVI-indices selected did not perform better (R2=0.7989, RMSE=38.69, MAE=30.98, MAPE=4.88%) compared to SLR with AutoVI-Chl. Finally, PLSR modelling performance for chlorophyll estimation was included as an additional benchmark for comparison. The PLSR model (R2=0.7379, RMSE=44.17, MAE=33.81, MAPE=5.36%) did not perform as well as SLR with AutoVI-Chl or SMLR with the selected AutoVI-indices (TABLE 5). Overall, the best modelling performance was provided by SLR with AutoVI-Chl, thus AutoVI may be an efficient system for novel trait-specific hyperspectral VI derivation.

TABLE 5 shows a comparison between different regression models for chlorophyll estimation with performance metrics calculated for simple linear regression (SLR) and stepwise multiple regression using AutoVI-derived indices or existing 47 vegetation indices, in addition to partial least of reflectance values for chlorophyll estimation on the test dataset with the best scores indicated in bold:

| Model | Feature(s) | R² | RMSE | MAE | MAPE |
|---|---|---|---|---|---|
| SLR | Auto VI-Chl | 0.8007 | 38.52 | 30.51 | 4.69% |
| SLR | NDCI | 0.6018 | 54.45 | 46.05 | 7.09% |
| SMLR | 7 Existing VIs | 0.7136 | 46.17 | 38.12 | 5.88% |
| SMLR | 4 Auto VI- | 0.7989 | 38.69 | 30.98 | 4.88% |
| | Indices | | | | |
| PLSR | Reflectance | 0.7379 | 44.17 | 33.81 | 5.36% |
| | Values | | | | |

In examples, for chlorophyll, the selected wavebands centred around the red (600-700 nm) and red-edge (700-740 nm) regions, with a few bands from the blue (470-490 nm), NIR (1000-1300 nm) and SWIR (1600-1700 nm) regions. Chlorophylls (chlorophyll a and b) are the most important plant pigments which function as photoreceptors and catalysts for photosynthesis, the photochemical synthesis of carbohydrates, so chlorophyll content in leaves and canopies is a key indicator of physiological measures such as photosynthetic capacity, developmental stage, productivity and stress, and reflectance of wavelengths in the red region (˜530-630 nm, and a narrower band around 700 nm) may be most sensitive to chlorophyll pigment concentrations across the normal range found in most leaves and canopies, and bands within the red-edge region (RE, 680-740 nm), which delineates the border between chlorophyll absorption in red wavelengths and leaf scattering in the NIR wavelengths, may be strongly correlated with chlorophyll content. Compared to existing chlorophyll VIs that consist mainly of 2-band indices derived from ratios of narrow bands within regions of spectrum sensitive to chlorophyll pigments (VIS-RE, 400-740 nm) and those areas not sensitive to the pigments and/or related to some other control on reflectance (typically NIR, 750-900 nm), the best VIs selected by AutoVI included additional wavebands, e.g., selected from the SWIR region, thus potentially enhancing the sensitivity the AutoVI-indices to chlorophyll, e.g., by acting as control on reflectance.

### Stepwise Multiple Linear Regression (SMLR) Method

The stepwise multiple linear regression (SMLR) method is a feature selection method that iteratively adds (forward selection) or removes (backward selection) features to a multiple linear regression model to improve model performance, as indicated by an evaluation metric or score. The experimental examples implemented a stepwise forward selection strategy based on a five-fold cross validated R² score of a multiple linear regression model using the Python package, scikit-learn version 0.24. The maximum number of features to select was set to between 1 and 20 and selection was performed on 25 AutoVI-derived indices and 46 or 47 published VIs for both chlorophyll and sugar estimation on the training dataset. A multiple linear regression model was fitted to the training dataset using the optimum selected features and used to predict target values (chlorophyll or sugar content) for the test dataset.

### Partial Least Squares Regression (PLSR) Method

The partial least-squares regression (PLSR) method is used for plant trait prediction using hyperspectral data. PLSR may address both collinearity between predictors, i.e., the different wavebands of a reflectance spectrum, and large number of predictor variables when compared to trait observations. The experimental examples implemented the PLSR method using the Python package, scikit-learn version 0.24 for chlorophyll and sugar content estimation. The optimal number of PLSR components was first determined based on five-fold cross validated R² scores of PLSR models fitted on the training dataset with the number of components set to between 1 and 20, and, in an example, the optimal number of components was n=6 for chlorophyll and n=7 for sugar as shown in FIGS. 11A and 11B respectively. A PLSR model was then fitted to the training dataset using the optimum number of components (n=6 for chlorophyll and n=7 for sugar) and used to predict target values (chlorophyll or sugar contents) for the test dataset.

### Sugar Content Estimation

In first estimation example, the AutoVI method and system were used to derive high quality novel hyperspectral VIs for plant phenotyping using total sugar content (μg/g) from a set of unpublished data collected from the NDCI, experiment (Banerjee et al., 2020). Sugar plays an important role in osmotic adjustment of plants in response to drought stress and studies have shown that genotypes which show higher accumulation of sugar content in leaves or stems are more drought tolerant (Adams et al., 2013; Piaskowski et al., 2016). In a first estimation instance, using the grouped model evaluation approach, the AutoVI optimizer steps were conducted across five repetitions with 20,000 iterations each and the coefficients were tuned, i.e., adjusted between 0 and 1. The overall best index model identified was compared to 46 conventional vegetation indices using R² scores computed for individual wheat growth time points (14, 21, 28 and 35 DAS) (TABLE 8) and across the entire wheat growth period (TABLE 7). In a second estimation example, the AutoVI optimizer steps were conducted across five repetitions with 20,000 iterations each with the coefficients fixed at 1: the dataset was split 65:35 into training and test datasets as described hereinbefore, with the training of AutoVI conducted on the training dataset and validation of derived indices performed on the test dataset. The resulting train-test split was used for subsequent AutoVI computations and regression modelling for estimation of sugar content. The effect of longer optimizations and inclusion of coefficient on model performance was determined as described hereinbefore. Results for SLR and SMLR using AutoVI-derived indices may be compared to those produced using 46 or 47 published VIs and PLSR modelling, as described hereinbefore.

For this example, the best index models resulting from the grouped model evaluations in the optimization steps showed high correlations (R²=0.72-0.82) to the total sugar content (as shown in FIG. 8). The overall best VI model (model26), termed hereinafter as “AutoVI sugar index” (AutoVI-SI) and depicted in the following equation, produced a R² of 0.8210 with N_{wb}=5 and N_{Cf}=3, where R_{wb} represents the reflectance measured at a discrete waveband (wb):

$$AutoVI - SI = \frac{( {R}_{1430} - {R}_{1670} ) - 0.9033 ( {R}_{1430} - {R}_{825} ) \frac{{R}_{1430}}{{R}_{1670}}}{0.9033 \frac{0.882 ( {R}_{791} - {R}_{825} ) - 0.2744 ( {R}_{1670} - {R}_{825} )}{\sqrt{{( {R}_{791} + 1 )}^{2} - ( {R}_{894} - 0.2744 . \sqrt{{R}_{1670}} ) - 0.5}}}$$

The second-best index model, model33 (N_{wb}=6, N_{cf}=1) had a R² of 0.8019, followed by model15 (N_{wb}=3) with R² of 0.7988, model25 (N_{wb}=4, Ncf=1) with R² of 0.7896 and finally model3 (N_{wb}=2) with R² of 0.7474 (as shown in FIG. 8 and in TABLE 6), suggesting that indices with N_{wb}≥3 may perform better compared to those limited to N_{wb}=2. Wavebands selected for the best index models in each model group were primarily from the shortwave infrared (SWIR) region spanning 1200-1700 nm, with band concentrations around 1410-1430 nm and between 1550-1680 nm (as shown in FIG. 9 and in TABLE 6). In addition, a few selected bands were from the near infrared (NIR) region spanning 800-900 nm (as shown in FIG. 9). The best R² score produced by AutoVI-SI was achieved using wavebands of 791 nm, 825 nm, 894 nm, 1430 nm and 1670 nm (as shown in TABLE 6).

TABLE 6 shows best-performing index models from grouped model evaluations for total sugar content estimation, wherein the optimization steps were performed on index models grouped according to N_{wb}, the best model from each group was identified from five repeated computations, and the overall best R² score is that of model26:

| | | | Selected | | |
|---|---|---|---|---|---|
| | | | W′length | Coeff | |
| Group | Model | Formula | (nm) | Value | R² |
| M2 | model3 | B1 − B2 | B1: 1424, | — | 0.7474 |
| | | | B2: 1571 | | |
| M3 | model15 | [(B1 − B2)/(B1 + B2)]/[(B1 − | B1: 1649, | — | 0.7988 |
| | | B3)/(B1 + B3)] | B2: 1176, | | |
| | | | B3: 1415 | | |
| M4 | model25 | [(B1 − B2) − α(B1 − B3)(B1/ | B1: 860, | α = 0.2593 | 0.7896 |
| | | B2)]/[(1 + a)(B4 − B2)/ | B2: 1663, | | |
| | | (B4 + B2 + α)] | B3: 1558, | | |
| | | | B4: 1409 | | |
| M5 | model26 | [(B1 − B2) − α(B1 − B3)(B1/ | B1: 1430, | α = 0.9033, | 0.8210 |
| | | B2)]/[α{β(B4 − B3) − ρ(B2 − | B2: 1670, | β = 0.8820, | |
| | | B3)/sqrt((B4 + 1)\hat{ }2 − (B5 − | B3: 825, | γ = 0.2744 | |
| | | ρ.2.sqrt(B2)) − 0.5)}] | B4: 791, | | |
| | | | B5: 894 | | |
| M6 | model33 | [(B1 − B2) − α(B1 − B3)(B1/ | B1: 555, | α = 0.9066 | |
| | | B2)]/[(1 + α)(B4 − B2)/ | B2: 1650, | | |
| | | (B4 + B2 + B5 + B6 + α)] | B3: 1339, | | |
| | | | B4: 1416, | | |
| | | | B5: 1195, | | |
| | | | B6: 1605 | | 0.8019 |

The best performing model, AutoVI-SI, was compared to 46 conventional vegetation indices for total sugar content estimation. In contrast to AutoVI-SI which

showed a strong correlation (R²=0.8089) to the measured sugar levels across the entire wheat growth period (as shown in FIG. 10A), most of the 46 or 47 vegetation indices had very low correlation (R²<0.1) with total sugar content, with a best result of R²=0.3879 recorded by the leaf structure index, LSI (Sridhar et al., 2007) (e.g., including the 46 shown in TABLE 7). A closer inspection at individual growth stages showed a varied response to total sugar content for AutoVI-SI with moderate to good correlation (R²=0.55-0.77) at later time points (as shown in FIG. 10B), whereas the majority of the published VIs only showed reasonable correlation (R²>0.5) with the measured sugar levels at the last time point, 35 DAS (as shown in TABLE 8). Some indices, such as the Vogelmann Red Edge Indices 1,2 and 3 (VOG1, VOG2 and VOG3) showed moderate correlation (R²=˜0.5) to total sugar content for individual growth stages (as shown in TABLE 8). In other words, AutoVI-SI performance correlated strongly (R²=0.82) with total sugar content across the entire wheat growth period, but performance was more varied across individual growth periods with a low correlation (R²=0.38) at early growth period and improving (R²=0.5-0.77) towards later vegetative stages. Overall, the AutoVI-SI system and method significantly outperformed traditional VIs for sugar content estimation across the entire wheat growth period with the best traditional VI, LSI producing R² of 0.39 only. These results support AutoVI-SI as a novel vegetation index for total sugar content estimation across the entire wheat growth period, with potential application at specific later growth periods.

TABLE 7 shows correlation of 46 conventional vegetation indices with total sugar content across the entire wheat growth period:

| Vegetation | |
|---|---|
| Index | R² |
| ari1 | 0.1264 |
| ari2 | 0.1197 |
| bri | 0.1489 |
| clsi | 0.0763 |
| crt2 | 0.1477 |
| dvi | 0.0029 |
| dwsi4 | 0.0427 |
| g | 0.0432 |
| gdvi | 0.0027 |
| gemi | 0.0342 |
| gmi1 | 0.0427 |
| gmi2 | 0.2414 |
| gndvi | 0.0053 |
| grvi | 0.0031 |
| ipvi | 0.0248 |
| lic1 | 0.0346 |
| lsi | 0.3879 |
| mcai | 0.0190 |
| mcari | 0.0948 |
| mcari2 | 0.0774 |
| mnli | 0.0005 |
| msi | 0.1019 |
| msr | 0.0291 |
| mtvi | 0.0496 |
| mtvi2 | 0.0774 |
| ndii | 0.1288 |
| ndvi | 0.0248 |
| ndwi | 0.1808 |
| nli | 0.0036 |
| nri1510 | 0.0768 |
| nri1850 | 0.0172 |
| osvi | 0.0342 |
| pri | 0.0682 |
| rdvi | 0.0104 |
| rendvi | 0.2267 |
| savi | 0.0146 |
| sr | 0.0304 |
| tcari | 0.1886 |
| tdvi | 0.0231 |
| tvi | 0.1954 |
| vog1 | 0.1007 |
| vog2 | 0.0496 |
| vog3 | 0.0491 |
| wbi | 0.1019 |
| wi | 0.0968 |
| zmi | 0.1333 |

TABLE 8 shows correlation of 46 conventional vegetation indices with total sugar content across individual wheat growth periods, wherein DAS=days after sowing:

| Vegetation | Time | |
|---|---|---|
| Index | Point | R² |
| ari1 | 14 DAS | 0.1196 |
| | 21 DAS | 0.2281 |
| | 28 DAS | 0.4310 |
| | 35 DAS | 0.5777 |
| ari2 | 14 DAS | 0.2002 |
| | 21 DAS | 0.1845 |
| | 28 DAS | 0.4661 |
| | 35 DAS | 0.5331 |
| bri | 14 DAS | 0.1039 |
| | 21 DAS | 0.2220 |
| | 28 DAS | 0.5004 |
| | 35 DAS | 0.5459 |
| clsi | 14 DAS | 0.0374 |
| | 21 DAS | 0.3945 |
| | 28 DAS | 0.0432 |
| | 35 DAS | 0.1817 |
| crt2 | 14 DAS | 0.0365 |
| | 21 DAS | 0.0024 |
| | 28 DAS | 0.4050 |
| | 35 DAS | 0.5860 |
| dvi | 14 DAS | 0.0127 |
| | 21 DAS | 0.0033 |
| | 28 DAS | 0.3868 |
| | 35 DAS | 0.6249 |
| dwsi4 | 14 DAS | 0.0141 |
| | 21 DAS | 0.0034 |
| | 28 DAS | 0.2696 |
| | 35 DAS | 0.4235 |
| g | 14 DAS | 0.0093 |
| | 21 DAS | 0.0001 |
| | 28 DAS | 0.2717 |
| | 35 DAS | 0.3961 |
| gdvi | 14 DAS | 0.0002 |
| | 21 DAS | 0.0222 |
| | 28 DAS | 0.4125 |
| | 35 DAS | 0.5790 |
| gemi | 14 DAS | 0.0576 |
| | 21 DAS | 0.0506 |
| | 28 DAS | 0.4388 |
| | 35 DAS | 0.5285 |
| gmi1 | 14 DAS | 0.0802 |
| | 21 DAS | 0.0374 |
| | 28 DAS | 0.2982 |
| | 35 DAS | 0.5996 |
| gmi2 | 14 DAS | 0.1312 |
| | 21 DAS | 0.1068 |
| | 28 DAS | 0.4998 |
| | 35 DAS | 0.6605 |
| gndvi | 14 DAS | 0.0011 |
| | 21 DAS | 0.0271 |
| | 28 DAS | 0.4734 |
| | 35 DAS | 0.5677 |
| grvi | 14 DAS | 0.0050 |
| | 21 DAS | 0.0251 |
| | 28 DAS | 0.4451 |
| | 35 DAS | 0.5745 |
| ipvi | 14 DAS | 0.0306 |
| | 21 DAS | 0.0063 |
| | 28 DAS | 0.4325 |
| | 35 DAS | 0.5618 |
| lic1 | 14 DAS | 0.0344 |
| | 21 DAS | 0.0084 |
| | 28 DAS | 0.4334 |
| | 35 DAS | 0.5746 |
| lsi | 14 DAS | 0.2611 |
| | 21 DAS | 0.0813 |
| | 28 DAS | 0.1968 |
| | 35 DAS | 0.6879 |
| mcai | 14 DAS | 0.0448 |
| | 21 DAS | 0.0258 |
| | 28 DAS | 0.2594 |
| | 35 DAS | 0.6672 |
| mcari | 14 DAS | 0.2968 |
| | 21 DAS | 0.4000 |
| | 28 DAS | 0.5115 |
| | 35 DAS | 0.0823 |
| mcari2 | 14 DAS | 0.0898 |
| | 21 DAS | 0.0514 |
| | 28 DAS | 0.4626 |
| | 35 DAS | 0.5502 |
| mnli | 14 DAS | 0.0380 |
| | 21 DAS | 0.0054 |
| | 28 DAS | 0.3958 |
| | 35 DAS | 0.6246 |
| msi | 14 DAS | 0.0088 |
| | 21 DAS | 0.1487 |
| | 28 DAS | 0.2815 |
| | 35 DAS | 0.6636 |
| msr | 14 DAS | 0.0409 |
| | 21 DAS | 0.0145 |
| | 28 DAS | 0.4266 |
| | 35 DAS | 0.6626 |
| mtvi | 14 DAS | 0.0671 |
| | 21 DAS | 0.0207 |
| | 28 DAS | 0.4400 |
| | 35 DAS | 0.5470 |
| mtvi2 | 14 DAS | 0.0898 |
| | 21 DAS | 0.0514 |
| | 28 DAS | 0.4626 |
| | 35 DAS | 0.5502 |
| ndii | 14 DAS | 0.1713 |
| | 21 DAS | 0.0866 |
| | 28 DAS | 0.3182 |
| | 35 DAS | 0.6803 |
| ndvi | 14 DAS | 0.0306 |
| | 21 DAS | 0.0063 |
| | 28 DAS | 0.4325 |
| | 35 DAS | 0.5618 |
| ndwi | 14 DAS | 0.0953 |
| | 21 DAS | 0.0965 |
| | 28 DAS | 0.3274 |
| | 35 DAS | 0.7368 |
| nli | 14 DAS | 0.0217 |
| | 21 DAS | 0.0055 |
| | 28 DAS | 0.3875 |
| | 35 DAS | 0.6249 |
| nri1510 | 14 DAS | 0.0089 |
| | 21 DAS | 0.0010 |
| | 28 DAS | 0.0638 |
| | 35 DAS | 0.3883 |
| nri1850 | 14 DAS | 0.0274 |
| | 21 DAS | 0.1023 |
| | 28 DAS | 0.5021 |
| | 35 DAS | 0.5573 |
| osvi | 14 DAS | 0.0576 |
| | 21 DAS | 0.0506 |
| | 28 DAS | 0.4388 |
| | 35 DAS | 0.5285 |
| pri | 14 DAS | 0.0183 |
| | 21 DAS | 0.0572 |
| | 28 DAS | 0.4236 |
| | 35 DAS | 0.5427 |
| rdvi | 14 DAS | 0.0020 |
| | 21 DAS | 0.0032 |
| | 28 DAS | 0.3807 |
| | 35 DAS | 0.5592 |
| rendvi | 14 DAS | 0.2962 |
| | 21 DAS | 0.2578 |
| | 28 DAS | 0.5837 |
| | 35 DAS | 0.5459 |
| savi | 14 DAS | 0.0272 |
| | 21 DAS | 0.0018 |
| | 28 DAS | 0.3707 |
| | 35 DAS | 0.5429 |
| sr | 14 DAS | 0.0475 |
| | 21 DAS | 0.0156 |
| | 28 DAS | 0.4163 |
| | 35 DAS | 0.6704 |
| tcari | 14 DAS | 0.4241 |
| | 21 DAS | 0.3788 |
| | 28 DAS | 0.6305 |
| | 35 DAS | 0.3717 |
| tdvi | 14 DAS | 0.0283 |
| | 21 DAS | 0.0043 |
| | 28 DAS | 0.4295 |
| | 35 DAS | 0.5606 |
| tvi | 14 DAS | 0.0038 |
| | 21 DAS | 0.0224 |
| | 28 DAS | 0.4018 |
| | 35 DAS | 0.5528 |
| vog1 | 14 DAS | 0.5364 |
| | 21 DAS | 0.4012 |
| | 28 DAS | 0.5678 |
| | 35 DAS | 0.5651 |
| vog2 | 14 DAS | 0.5115 |
| | 21 DAS | 0.3892 |
| | 28 DAS | 0.5317 |
| | 35 DAS | 0.6204 |
| vog3 | 14 DAS | 0.5420 |
| | 21 DAS | 0.3880 |
| | 28 DAS | 0.5301 |
| | 35 DAS | 0.6209 |
| wbi | 14 DAS | 0.0088 |
| | 21 DAS | 0.1487 |
| | 28 DAS | 0.2815 |
| | 35 DAS | 0.6636 |
| wi | 14 DAS | 0.3865 |
| | 21 DAS | 0.0476 |
| | 28 DAS | 0.3854 |
| | 35 DAS | 0.5745 |
| zmi | 14 DAS | 0.3304 |
| | 21 DAS | 0.3415 |
| | 28 DAS | 0.5603 |
| | 35 DAS | 0.5655 |

For sugar, the selected wavebands were predominantly from the SWIR region (1200-1700 nm), with additional bands from the NIR region (800-900 nm). It is known that leaf reflectance properties in the SWIR region is governed by water content and biochemical compounds such as cellulose, sugars and starch (Elvidge, 1990; Kokaly et al., 2009). In addition, a recent study in rice has identified the NIR region (800-1100 nm) as being important for sugar content estimation (Das et al., 2018). These studies provide support for bands selected by the AutoVI method and system as being specific to total sugar content. The AutoVI method and system was able to select bands from the SWIR region whilst avoiding the water vapor absorption peak around 1450 nm, which tend to obscure spectral signatures for estimation of biochemical compounds in plants (Elvidge, 1990; Kokaly et al., 2009). These results affirm the efficacy of the AutoVI method and system in selecting biologically relevant hyperspectral bands specific to the trait of interest.

In the second estimation example, the AutoVI performance across five repetitions was relatively stable, with the M6 group having the best mean R2 of 0.8201, followed by M3 group with R² of 0.8127, M4 group with R² of 0.7933, M5 group with R² of 0.7877 and finally M2 group with R² of 0.7591 (FIG. 5B3). The overall best VI was produced by Index33 (Nwb=6, Ncf=1), which also generated the best results for three repetitions within the M6 group (FIG. 51B). The performance of the best VIs according to model group is summarized in TABLE 9.

TABLE 9 shows performance of the best AutoVI-derived indices according to model group for sugar estimation with performance metrics calculated for simple linear regression using the indicated AutoVI-derived index for chlorophyll estimation on the test dataset and the best scores are indicated in bold:

| | | Selected | | | | |
|---|---|---|---|---|---|---|
| | Index | Wavelengths | | | | |
| Group | Model | (nm) | R² | RMSE | MAE | MAPE |
| M2 | 3 | 1420, 1588 | 0.7693 | 3078.89 | 2493.21 | 22.94% |
| M3 | 15 | 1271, 1417, 1650 | 0.8209 | 2712.72 | 2237.33 | 20.31% |
| M4 | 24 | 1371, 1422, 1650, | 0.8055 | 2827.07 | 2466.19 | 23.57% |
| | | 1712 | | | | |
| M5 | 29 | 644, 990, 1406, | 0.7860 | 2964.88 | 2387.41 | 21.66% |
| | | 1418, 1649 | | | | |
| M6 | 33 | 499, 773, 1179, | 0.8339 | 2612.41 | 2148.15 | 20.17% |
| | | 1291, 1425, 1661 | | | | |

In this example, the wavebands selected by AutoVI for the best sugar indices derived predominantly from the shortwave infrared (1400-1700 nm) and near infrared (770-1370 nm) regions, with a few bands from the VIS (499-644 nm) region (TABLE 9). The R² score produced by the best VI, termed hereafter as AutoVI sugar index (AutoVI-Sgr), was achieved using wavebands of 499 nm, 773 nm, 1179 nm, 1291 nm, 1425 nm and 1661 nm, without coefficient tuning (i.e. value set to 1), as depicted in the following equation where R_{wb} represents the reflectance measured at a discrete waveband (wb):

$$AutoVI - Sgr = \frac{( {R}_{773} - {R}_{1425} ) - ( {R}_{773} - {R}_{1179} ) \frac{{R}_{773}}{{R}_{1425}}}{( 2 ) \frac{( {R}_{1661} - {R}_{1425} )}{( {R}_{1661} + {R}_{1425} + {R}_{499} + {R}_{1291} + 1 )}}$$

The inclusion of the coefficient, alpha (α), in AutoVI-Sgr as depicted in its original equation (Model Name 33, “Index33”, TABLE 1) and longer optimizations at 40,000 iterations did not significantly improve its performance (FIG. 6C). For the longer runs (40 k iterations) with or without the coefficient, performance may converge closer and plateau at R² of ˜0.83, thus this may be the maximum performance afforded by the underlying model equation (FIG. 6C). In this example, the recommended starting point for AutoVI training is up to 20,000 iterations and without coefficient tuning.

In this example, the quality of AutoVI-derived indices for sugar content estimation were evaluated further against 47 published VIs, as features in simple linear regression (SLR) modelling. The best SLR performance with AutoVI-derived indices was achieved using AutoVI-Sgr (R²=0.8339, RMSE=2612.41, MAE=2148.15, MAPE=20.17%), which significantly outperformed the best SLR model achieved with the published VI, Gitelson and Merzlyak Index 2, GMI2 (R²=0.4695, RMSE=4668.35, MAE=3939.59, MAPE=38.96%). In general, SLR modelling performance with existing VIs was very poor. SMLR with five existing VIs selected produced better results (R²=0.7387, RMSE=3276.50, MAE=2401.14, MAPE=22.30%) compared to SLR with GMI2 but was still inferior to the model with AutoVI-Sgr (TABLE 10). On the other hand, SMLR with four AutoVI-indices selected performed better (R²=0.8587, RMSE=2409.19, MAE=2071.47, MAPE=19.16%) compared to SLR with AutoVI-Sgr (TABLE 10). PLSR modelling performance for sugar estimation was also included as a benchmark for comparison. The PLSR model had similar performance (R²=0.8322, RMSE=2625.99, MAE=2212.89, MAPE=21.19%) as SLR with AutoVI-Sgr but was outperformed by SMLR with the AutoVI-indices (TABLE 10). These results further support AutoVI as a possible efficient system for novel VI derivation, with AutoVI-indices as high-quality features for trait prediction.

TABLE 10 is a comparison between different regression models for sugar estimation with performance metrics calculated for simple linear regression (SLR) and stepwise multiple regression (MLR) using AutoVI-derived indices or existing 47 vegetation indices, in addition to partial least ression (PLSR) using the full spectrum of reflectance values for sugar estimation on the test dataset with the best scores for this example indicated in bold:

| Model | Feature(s) | R² | RMSE | MAE | MAPE |
|---|---|---|---|---|---|
| SLR | Auto VI-Sgr | 0.8339 | 2612.41 | 2148.15 | 20.17% |
| SLR | GMI2 | 0.4695 | 4668.95 | 3939.59 | 38.96% |
| SMLR | 5 Existing VIs | 0.7387 | 3276.50 | 2401.14 | 22.30% |
| SMLR | 4 Auto VI- | 0.8587 | 2409.19 | 2071.47 | 19.16% |
| | Indices | | | | |
| PLSR | Reflectance | 0.8322 | 2625.99 | 2212.89 | 21.19% |
| | Values | | | | |

### INTERPRETATION

Many modifications will be apparent to those skilled in the art without departing from the scope of the present invention.

The presence of “/” in a FIG. or text herein is understood to mean “and/or”, i.e., “X/Y” is to mean “X” or “Y” or “both X and Y”, unless otherwise indicated. The recitation of a particular numerical value or value range herein is understood to include or be a recitation of an approximate numerical value or value range, for instance, within +/−20%, +/−15%, +/−10%, +/−5%, +/−2.5%, +/−2%, +/−1%, +/−0.5%, or +/−0%. The terms “substantially” and “essentially all” can indicate a percentage greater than or equal to 90%, for instance, 92.5%, 95%, 97.5%, 99%, or 100%.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### LIST OF REFERENCES

Aasen H, Gnyp M L, Miao Y, Bareth G. 2014. Automated Hyperspectral Vegetation Index Retrieval from Multiple Correlation Matrices with HyperCor. Photogrammetric Engineering & Remote Sensing 80(8): 785-795.
Aasen H, Honkavaara E, Lucieer A, Zarco-Tejada P J. 2018. Quantitative remote sensing at ultra-high resolution with UAV spectroscopy: a review of sensor technology, measurement procedures, and data correction workflows. Remote Sensing 10(7): 1091.
Adams H D, Germino M J, Breshears D D, Barron-Gafford G A, Guardiola-Claramonte M, Zou C B, Huxman T E. 2013. Nonstructural leaf carbohydrate dynamics of Pinus edulis during drought-induced tree mortality reveal role for carbon metabolism in mortality mechanism. New Phytologist 197(4): 1142-1151.
Adão T, Hruška J, Pádua L, Bessa J, Peres E, Morais R, Sousa J J. 2017. Hyperspectral Imaging: A Review on UAV-Based Sensors, Data Processing and Applications for Agriculture and Forestry. Remote Sensing 9(11): 1110.
Bajwa S G, Kulkari S S. 2011. Hyperspectral data mining: Boca Raton, London, New York: CRC Press/Taylor and Francis Group.
Banerjee B P, Joshi S, Thoday-Kennedy E, Pasam R K, Tibbits J, Hayden M, Spangenberg G, Kant S. 2020. High-throughput phenotyping using digital and hyperspectral imaging-derived biomarkers for genotypic nitrogen response. Journal of Experimental Botany.
Bergstra J, Bardenet R, Bengio Y, Kégl B 2011. Algorithms for hyper-parameter optimization. Proceedings of the 24th International Conference on Neural Information Processing Systems. Granada, Spain: Curran Associates Inc. 2546-2554.
Bergstra J, Komer B, Eliasmith C, Yamins D, Cox D D. 2015. Hyperopt: a Python library for model selection and hyperparameter optimization. Computational Science & Discovery 8(1): 014008.
Blackburn G A. 2006. Hyperspectral remote sensing of plant pigments. Journal of Experimental Botany 58(4): 855-867.
Burger J, Gowen A. 2011. Data handling in hyperspectral image analysis. Chemometrics and Intelligent Laboratory Systems 108(1): 13-22.
Chauhan H J, Mohan B K. 2013. Development of agricultural crops spectral library and classification of crops using Hyperion hyperspectral data. Journal of Remote Sensing Technology 1(1): 9.
Croft H, Chen J M, Luo X, Bartlett P, Chen B, Staebler R M. 2017. Leaf chlorophyll content as a proxy for leaf photosynthetic capacity. Global Change Biology 23(9): 3513-3524.
Das B, Sahoo R N, Pargal S, Krishna G, Verma R, Chinnusamy V, Sehgal V K, Gupta V K, Dash S K, Swain P. 2018. Quantitative monitoring of sucrose, reducing sugar and total sugar dynamics for phenotyping of water-deficit stress tolerance in rice through spectroscopy and chemometrics. Spectrochimica Acta Part A: Molecular and Biomolecular Spectroscopy 192: 41-51.
Din M, Zheng W, Rashid M, Wang S, Shi Z. 2017. Evaluating Hyperspectral Vegetation Indices for Leaf Area Index Estimation of Oryza sativa L. at Diverse Phenological Stages. Frontiers in plant science 8(820).
Elvidge C D. 1990. Visible and near infrared reflectance characteristics of dry plant materials. International Journal of Remote Sensing 11(10): 1775-1795.
Gitelson A A, Vina A, Ciganda V, Rundquist D C, Arkebauer T J. 2005. Remote estimation of canopy chlorophyll content in crops. Geophysical Research Letters 32(8).
Gnyp M L, Miao Y, Yuan F, Ustin S L, Yu K, Yao Y, Huang S, Bareth G. 2014. Hyperspectral canopy sensing of paddy rice aboveground biomass at different growth stages. Field Crops Research 155: 42-55.
Henrich V, Krauss G, Götze C, Sandow C 2017. Index Database: A database for remote sensing indices.
Hinneburg A, Keim D A 1999. Optimal grid-clustering: Towards breaking the curse of dimensionality in high-dimensional clustering.
Huete A R. 1988. A soil-adjusted vegetation index (SAVI). Remote Sensing of Environment 25(3): 295-309.
Kokaly R F, Asner G P, Ollinger S V, Martin M E, Wessman C A. 2009. Characterizing canopy biochemistry from imaging spectroscopy and its application to ecosystem studies. Remote Sensing of Environment 113: S78-S91.
Koppe W, Li F, Gnyp M L, Miao Y X, Jia L L, Chen X P, Zhang F S, Bareth G. 2010. Evaluating Multispectral and Hyperspectral Satellite Remote Sensing Data for Estimating Winter Wheat Growth Parameters at Regional Scale in the North China Plain. Photogrammetrie Fernerkundung Geoinformation(3): 167-178.
Li F, Miao Y, Hennig S D, Gnyp M L, Chen X, Jia L, Bareth G. 2010. Evaluating hyperspectral vegetation indices for estimating nitrogen concentration of winter wheat at different growth stages. Precision Agriculture 11(4): 335-357.
Lichtenthaler H K 1987. [34] Chlorophylls and carotenoids: Pigments of photosynthetic biomembranes. Methods in Enzymology: Academic Press, 350-382.
Liu C, Sun P, Liu S. 2016. A review of plant spectral reflectance response to water physiological changes. Chinese Journal of Plant Ecology 40(1): 80-91.
Lu B, Dao P D, Liu J, He Y, Shang J. 2020. Recent Advances of Hyperspectral Imaging Technology and Applications in Agriculture. Remote Sensing 12(16): 2659.
Mir R R, Reynolds M, Pinto F, Khan M A, Bhat M A. 2019. High-throughput phenotyping for crop improvement in the genomics era. Plant Sci 282: 60-72.
Mishra P, Asaari M S M, Herrero-Langreo A, Lohumi S, Diezma B, Scheunders P. 2017. Close range hyperspectral imaging of plants: A review. Biosystems Engineering 164: 49-67.
Murchie E H, Lawson T. 2013. Chlorophyll fluorescence analysis: a guide to good practice and understanding some new applications. Journal of Experimental Botany 64(13): 3983-3998.
Pearson R L, Miller L D 1972. Remote mapping of standing crop biomass for estimation of the productivity of the shortgrass prairie, Pawnee National Grasslands, Colorado.
Piaskowski J L, Brown D, Campbell K G. 2016. Near-Infrared Calibration of Soluble Stem Carbohydrates for Predicting Drought Tolerance in Spring Wheat. Agronomy Journal 108(1): 285-293.
Qi J, Chehbouni A, Huete A R, Kerr Y H, Sorooshian S. 1994. A Modified Soil Adjusted Vegetation Index. Remote Sensing of Environment 48(2): 119-126.
Rao N R, Garg P K, Ghosh S K. 2007. Development of an agricultural crops spectral library and classification of crops at cultivar level using hyperspectral data. Precision Agriculture 8(4): 173-185.
Richardson A D, Duigan S P, Berlyn G P. 2002. An evaluation of noninvasive methods to estimate foliar chlorophyll content. New Phytologist 153(1): 185-194.
Rondeaux G, Steven M, Baret F. 1996. Optimization of soil-adjusted vegetation indices. Remote Sensing of Environment 55(2): 95-107.
Rouse J, Haas R, Schell J, Deering D, Harlan J. 1974. Monitoring the vernal advancement of retrogradation of natural vegetation (p. 371). Greenbelt, MD: NASA GSFC (Type III, Final Report).
Silleos N G, Alexandridis T K, Gitas I Z, Perakis K. 2006. Vegetation Indices: Advances Made in Biomass Estimation and Vegetation Monitoring in the Last 30 Years. Geocarto International 21(4): 21-28.
Sridhar B B M, Han F X, Diehl S V, Monts D L, Su Y. 2007. Spectral reflectance and leaf internal structure changes of barley plants due to phytoextraction of zinc and cadmium. International Journal of Remote Sensing 28(5): 1041-1054.
Stroppiana D, Boschetti M, Brivio P A, Bocchi S. 2009. Plant nitrogen concentration in paddy rice from field canopy hyperspectral radiometry. Field Crops Research 111(1): 119-129.
Sun W, Du Q. 2019. Hyperspectral Band Selection: A Review. IEEE Geoscience and Remote Sensing Magazine 7(2): 118-139.
Tardieu F, Cabrera-Bosquet L, Pridmore T, Bennett M. 2017. Plant Phenomics, From Sensors to Knowledge. Curr Biol 27(15): R770-r783.
Thenkabail P S, Enclona E A, Ashton M S, Van Der Meer B. 2004. Accuracy assessments of hyperspectral waveband performance for vegetation analysis applications. Remote Sensing of Environment 91(3): 354-376.
Thenkabail P S, Lyon J G, Huete A. 2011. Advances in hyperspectral remote sensing of vegetation and agricultural croplands: Chapter 1: CRC Press.
Thenkabail P S, Smith R B, De Pauw E. 2000. Hyperspectral Vegetation Indices and Their Relationships with Agricultural Crop Characteristics. Remote Sensing of Environment 71(2): 158-182.
Wen P-F, He J, Ning F, Wang R, Zhang Y-H, Li J. 2019. Estimating leaf nitrogen concentration considering unsynchronized maize growth stages with canopy hyperspectral technique. Ecological Indicators 107: 105590.
Winston P H. 1992. Artificial intelligence (3rd ed.): Addison-Wesley Longman Publishing Co., Inc.
Xu M, Liu R, Chen J M, Liu Y, Shang R, Ju W, Wu C, Huang W. 2019. Retrieving leaf chlorophyll content using a matrix-based vegetation index combination approach. Remote Sensing of Environment 224: 60-73.
Xue J, Su B. 2017. Significant Remote Sensing Vegetation Indices: A Review of Developments and Applications. Journal of Sensors 2017: 1353691.
Yao X, Liu Y 1997. Fast evolution strategies. Berlin, Heidelberg: Springer Berlin Heidelberg. 149-161.
Yemm E W, Willis A J. 1954. The estimation of carbohydrates in plant extracts by anthrone. The Biochemical journal 57(3): 508-514.
Yu T, Zhu H. 2020. Hyper-Parameter Optimization: A Review of Algorithms and Applications. ArXiv abs/2003.05689.
Zhang C, Kovacs J M. 2012. The application of small unmanned aerial systems for precision agriculture: a review. Precision Agriculture 13(6): 693-712.
Zhu Y, Wang W, Yao X. 2012. Estimating leaf nitrogen concentration (LNC) of cereal crops with hyperspectral data. Hyperspectral remote sensing of vegetation: 187-206.

### Computer Program Listing

In the following example computer program listing, human-readable comments are preceded by “#”.

| | |
|---|---|
| 1. | # Import libraries |
| 2. | import optuna # open-source hyperparameter optimization package |
| | with TPE optimizer |
| 3. | import pandas as pd # open-source data analysis and manipulation |
| | tool |
| 4. | import Models # custom Models class encoding all 33 index models |
| 5. | |
| 6. | # Load csv files as pandas dataframes |
| 7. | x = pd.read_csv(‘HS.csv’) # hyperspectral reflectance values in |
| | csv file |
| 8. | y = pd.read_csv(‘Trait.csv’) # trait values in csv file |
| 9. | nb_x = x.shape[1] # total number of bands in x |
| 10. | |
| 11. | # Define objective function |
| 12. | def objective(trial): |
| 13. | # select model from list of 33 candidates - STEP1 |
| 14. | model_index = trial.suggest_int(‘model_index’, 0, 32) |
| 15. | model = Models(model_index) # instantiate selected model |
| 16. | |
| 17. | # get number of wavebands (nwb) and number of coefficients |
| | (ncf) - STEP2 |
| 18. | nwb, ncf = model.params |
| 19. | |
| 20. | # Select optimum wavebands - STEP3 |
| 21. | selected_bands = [ ] # create empty list to store selected |
| | bands |
| 22. | b1_index = trial.suggest_int(‘b1_index’, 0, nb_x − 1) |
| 23. | b2_index = trial.suggest_int(‘b2_index’, 0, nb_x − 2) |
| 24. | selected_bands.append(b1_index, b2_index) |
| 25. | if nwb >= 3: |
| 26. | b3_index = trial.suggest_int(‘b3_index’, 0, nb_x − 3) |
| 27. | selected_bands.append(b3_index) |
| 28. | if nwb >= 4 : |
| 29. | b4_index = trial.suggest_int(‘b4_index’, 0, nb_x − 4) |
| 30. | selected_bands.append(b4_index) |
| 31. | if nwb >= 5: |
| 32. | b5_index = trial.suggest_int(‘b5_index’, 0, nb_x − 5) |
| 33. | selected_bands.append(b5_index) |
| 34. | if nwb >= 6: |
| 35. | b6_index = trial.suggest_int(‘b6_index’, 0, nb_x − 6) |
| 36. | selected_bands.append(b6_index) |
| 37. | |
| 38. | # Select optimum coefficient values between 0.0 and 1.0 - STEP3 |
| 39. | cf_val = [ ] # create empty list to store coefficient values |
| 40. | if ncf >= 1: |
| 41. | alpha = trial.suggest_uniform(‘alpha’, 0.0, 1.0) |
| 42. | cf_val.append(alpha) |
| 43. | if ncf >= 2: |
| 44. | beta = trial.suggest_uniform(‘beta’, 0.0, 1.0) |
| 45. | cf_val.append(beta) |
| 46. | if ncf >= 3: |
| 47. | gamma = trial.suggest_uniform(‘gamma’, 0.0, 1.0) |
| 48. | cf_val.append(gamma) |
| 49. | if ncf >= 4: |
| 50. | delta = trial.suggest_uniform(‘delta’, 0.0, 1.0) |
| 51. | cf_val.append(delta) |
| 52. | if ncf >= 5: |
| 53. | epsilon = trial.suggest_uniform (‘epsilon’, 0.0, 1.0) |
| 54. | cf_val.append(epsilon) |
| 55. | |
| 56. | # Evaluate model - STEP4 |
| 57. | score = model.evaluate(x, y, selected_bands, cf_val) # |
| | calculate R2 based on selected hyperparameters |
| 58. | return score |
| 59. | |
| 60. | # Initiate AutoVI optimization with TPE (optimizer in optuna) |
| 61. | study = optuna.create_study(direction=‘maximize’) # increase |
| | objective function (R2 score) |
| 62. | study.optimize(objective, n_trials=20,000, n_jobs=−1) # run |
| | optimization for 20,000 trials/iterations with parallel processing |
| | (n_jobs=−1) |
| 63. | study.best_params # get the best model and associated |
| | hyperparameters |

1. A method for automated hyperspectral vegetation index (VI) determination, the method including:
accessing measured spectra and respective measured ground truth values of a selected vegetation trait;
accessing a library of VI models, wherein each VI model includes a relationship defining an index value for the vegetation trait by mathematically combining spectral measurement values at a plurality of wavebands (“model wavebands”), optionally with one or more coefficients (“model coefficients”);
a model selection step, including selecting a VI model from the library of VI models;
a model parameter generation step, including:
generating a hyperparameter for each of the spectral measurement values of the selected VI model, wherein the hyperparameter includes a selected waveband for each of the plurality of model wavebands, and
generating a hyperparameter for each of the model coefficients of the selected VI model if the selected VI model has any coefficients, wherein the hyperparameter includes a selected coefficient value for each of the model coefficients;
a model evaluation step, including evaluating the selected VI model with the selected wavebands and optionally selected coefficient values with an objective function score, wherein the objective function score quantifies a closeness of fit between the ground truth values and calculated VI values from the selected VI model with the generated hyperparameters and the respective measured spectra;
a model parameter tuning step, including using an optimizer to select the waveband for each of the at least two wavebands (“optimum wavebands”), and optionally to select the coefficient values for each of the coefficients (“optimum coefficient values”) based on sequential model-based optimization (SMBO); and
repeating the model selection step, the model parameter generation step, the model evaluation step and the model parameter tuning step (together referred to as the “optimization steps”) for a plurality of iterations.

2. The method of claim 1, including:
selecting the VI model from the plurality of iterations with the selected optimum wavebands and optimum coefficient values, which is the VI model with model parameters that generates the highest objective function score over all iterations.

3. The method of claim 1, including:
a grouping step, including grouping VI models from the library according the number (Nwb) of the model wavebands, including a first group with a plurality of two-waveband models (Nwb=2) and a second group with a plurality of three-waveband models (Nwb=3);
a running step, including determining the best-performing VI model within each group by performing the plurality of the iterations of the optimization steps for each group; and
a cross-group comparison step, including selecting an overall best VI model from the best-performing VI models based on their respective objective function scores.

4. The method of claim 1, including:
creating the library of VI models.

5. The method of claim 1, wherein the SMBO is Bayesian SMBO and the optimizer is a Bayesian optimizer.

6. The method of claim 5, wherein the Bayesian optimizer is a Tree-Structured Parzen Estimator (TPE).

7. The method of claim 1, including:
analysing samples of the plant to generate the measured spectra and the ground truth values of the plant.

8. The method of claim 7, wherein the measured spectra include reflectance spectra.

9. The method of claim 7, including:
using a hyperspectral imaging sensor or spectrometer to generate the measured spectra.

10. The method of claim 7, wherein the analysing of the samples of the plant includes: imaging the plants at a plurality of mutually different angles.

11. The method of claim 10, wherein the plurality of mutually different angles includes 0°, 120°, and 240°.

12. The method of claim 10, including: rotating the plants to the plurality of mutually different angles using a lifter and turner assembly.

13. The method of claim 1, wherein the model wavebands include a plurality of wavebands in one or more of:
a visible region with wavelengths 400-700 nm;
a near infrared region with wavelengths 700-1000 nm;
a shortwave infrared region with wavelengths 1000-2500 nm;
a shortwave infrared region with wavelengths 1200-1700 nm;
a region with wavelengths 1410-1430 nm;
a region with wavelengths 1550-1680 nm;
a near infrared region with wavelengths 800-900 nm; and
a region with wavelengths 400-5,400 nm.

14. The method of claim 1, wherein the model wavebands include: over 1,000 wavebands, over 2,000 wavebands, over 3,000 wavebands, over 4,000 wavebands, or over 5,000 wavebands.

15. The method of claim 14, wherein a number of the wavebands is selected based on a number of the wavebands measured by a hyperspectral imaging sensor or spectrometer.

16. A system configured to perform the method of claim 1, the system including:
an optimizer module configured to perform the optimization steps, including the model selection step, the model parameter generation step, the model parameter tuning step and the model evaluation step; and
optionally one or more hyperspectral sensors.

17. (canceled)

18. The system of claim 16, including: an unmanned aerial vehicle (UAV) system with the one or more hyperspectral sensors.

19. The system of claim 16, including:
a hyperspectral imaging station to generate the spectrum; and
a lifter and turner assembly for imaging plants at a plurality of mutually different angles to generate the measured spectra of the plant.

20. The system of claim 19, wherein the hyperspectral imaging station includes a pushbroom-type imaging spectrometer, optionally operational over a spectral range of 475-1710 nm and a spectral resolution of less than 10 nm.

21. Machine-readable storage media including machine readable instructions that, when executed by a computing system, perform data-processing steps of the method of claim 1, including one or more of the accessing steps, the model selection step, the model parameter generation step, the model parameter tuning step, the model selection step, the grouping step, the running step, and the cross-group comparison step.
